(19) United States
(12) Patent Application Publication
(10) Pub. No.: US 2026/0212223 A1
(43) Pub. Date: Jul. 23, 2026

(54) First Node, Second Node and Methods Performed Thereby, for Handling One or More Machine Learning Models

(71) Applicant: Telefonaktiebolaget LM Ericsson (publ), Stockholm (SE)

(72) Inventors: Ranjani H.G, Karnataka (IN); Akshat Vikram, Karnataka (IN); Mahesh Babu Jayaraman, Karnataka (IN); Barjinder Singh Kochar, New Dehli (IN); Sunil Kumar Vuppala, Bangalore (IN); Ajay Sharma, Karnataka (IN)

(21) Appl. No.: 19/140,557

(22) PCT Filed: Dec. 19, 2022
(86) PCT No.: PCT/IN2022/051100

§ 371 Date: Jun. 18, 2025

(51) Int. Cl. G06N 5/04

(52) U.S. Cl. CPC G06N 5/04

(57) ABSTRACT

A computer-implemented method performed by a first node (111). The methods is for handling one or more machine learning models. The first node (111) operates in a communications system (100). The first node (111) determines (404), using machine learning, ML, one or more ML models of an indicator of operation of the communications system (100). The determining (404) is based on a respective operation mode of Radio Access Technology (RAT), used by a respective set of nodes (121,122,123) wherefrom respective data has been collected to train, or infer, a respective ML model of the one or more ML models. The first node (111) also provides (405) a respective indication of the determined one or more ML models to a second node (112) operating in the communications system (100).

### TECHNICAL FIELD

The present disclosure relates generally to a first node and methods performed thereby for handling one or more machine learning (ML) models. The present disclosure further relates generally to a second node and methods performed thereby, for handling the ML models. The present disclosure also relates generally to computer programs and computer-readable storage mediums, having stored thereon the computer programs to carry out these methods.

### BACKGROUND

Computer systems in a communications network or communications system may comprise one or more nodes. A node may comprise one or more processors which, together with computer program code may perform different functions and actions, a memory, a receiving port, and a sending port. A node may be, for example, a server. Nodes may perform their functions entirely on the cloud.

Computer systems may be comprised in a telecommunications network. The telecommunications network may cover a geographical area which may be divided into cell areas, each cell area being served by a type of node, a network node in the Radio Access Network (RAN), radio network node or Transmission Point (TP), for example, an access node such as a Base Station (BS), e.g., a Radio Base Station (RBS), which sometimes may be referred to as e.g., gNB, evolved Node B (“eNB”), “eNodeB”, “NodeB”, “B node”, or Base Transceiver Station (BTS), depending on the technology and terminology used. The base stations may be of different classes such as e.g., Wide Area Base Stations, Medium Range Base Stations, Local Area Base Stations and Home Base Stations, based on transmission power and thereby also cell size. A cell may be understood to be the geographical area where radio coverage may be provided by the base station at a base station site. One base station, situated on the base station site, may serve one or several cells. Further, each base station may support one or several communication technologies. The telecommunications network may also comprise network nodes which may serve receiving nodes, such as user equipments, with serving beams.

In the course of operations of the telecommunications network, data may be collected on the performance of the telecommunications network, which may enable to monitor and manage the malfunctioning of any of its elements.

The advent of for example, the Internet of Things (IoT) has exponentially increased the amount of data to be monitored. The availability of large amounts of data, such as those collected for example, from IoT devices, may be understood to enable the possibility of analysing such data to make predictions on events, with a high predictive power. To make predictions on events may be understood to refer to building mathematical models that may fit those data, which mathematical models may then be used to make predictions for such events. Within this context, machine learning models may be used to analyze the data collected, and enable an improved management of the operation of the telecommunications network.

### Machine Learning

Machine learning (ML) may be understood as the study of computer algorithms that may improve automatically through experience. It is seen as a part of Artificial Intelligence (AI). ML algorithms may build a model based on sample data, known as “training data”, in order to make predictions or decisions without being explicitly programmed to do so. ML algorithms may be used in a wide variety of applications, such as email filtering and computer vision, where it may be difficult or unfeasible to develop conventional algorithms to perform the needed tasks.

There may be basically 3 types of ML Algorithms: Supervised Learning, Unsupervised Learning, and Reinforcement Learning (RL).

Supervised Learning algorithms may comprise a target/outcome variable, or dependent variable, which may have to be predicted from a given set of predictors, that is, independent variables. Using this set of variables, a function may be generated that may map inputs to desired outputs. The training process may continue until the model may achieve a desired level of accuracy on the training data. Once an ML model may have been trained, an inference process may begin, whereby new data may be run through the ML model to calculate an output. Examples of Supervised Learning may be Regression, Decision Tree, Random Forest, KNN, Logistic Regression etc.

In Unsupervised Learning algorithms, there may be no target or outcome variable to predict/estimate. It may be used for clustering a population into different groups, which may be widely used for segmenting customers in different groups for specific intervention. Examples of Unsupervised Learning may be K-means, mean-shift clustering, Density-Based Spatial Clustering of Applications with Noise (DBSCAN), Expectation-Maximization (EM) Clustering using Gaussian Mixture Models (GMM), Agglomerative Hierarchical Clustering, etc . . . .

Cluster analysis or clustering may be understood as an ML technique which may comprise grouping a set of objects in such a way that objects in the same group, which may be called a cluster, may be understood to be more similar, in some sense, to each other than to those in other groups, that is, other clusters. It may be understood as a main task of exploratory data mining, and a common technique for statistical data analysis, used in many fields, including pattern recognition, image analysis, information retrieval, bioinformatics, data compression, computer graphics and ML.

Using an RL algorithm, a machine may be trained to make specific decisions. It may be understood to work as follows: the machine may be exposed to an environment where it may train itself continually using trial and error. This machine may learn from past experience and may try to capture the best possible knowledge to make accurate business decisions. An example of RL may be a Markov Decision Process (MDP). The training using RL may comprise generating an ML model. To train such an ML model, an agent, given a state of the environment, may take an action in this environment and receive a reward. The action may result in a new state of the environment. This process may be repeated in a loop. Over time, the agent may learn to take actions that may result in larger immediate and future rewards, meaning that it may be understood to be in the best interest of the agent not to take the action that may only lead to the highest reward in the next state, but the action that may cumulatively lead to the highest reward in the next state and in a future number of states.

The agent may comprise a neural network which may input the state and may produce an action. There may be several ML algorithms that may be used for training the network of the agent, e.g., policy-learning based, such as actor-critic approaches or value-based learning such as deep-q networks.

Network traffic management may be understood to be relevant for optimal utilization of the limited spectrum in a telecommunication network. Network radio resources may be understood to be limited, and network operators may need to find efficient ways to manage the time-varying, high bandwidth and connectivity requirements of the end users.

The standardization organization Third Generation Partnership Project (3GPP) is currently in the process of specifying a New Radio Interface called Next Generation Radio or New Radio (NR), as well as a Fifth Generation (5G) Packet Core Network, which may be referred to as 5G Core Network (5GC). The advantages of 5G NR may include higher bandwidth, more resources, low latency and network slicing. 5G may provide services to various applications, such as enhanced Mobile Broad Band (eMBB), machine to Machine type communication (mMTC), Ultra Reliable Low Latency Communication (URLLC).

Similar to Fourth Generation (4G), 5G network traffic management may be understood to involve monitoring network traffic through Key Performance Indicators (KPIs), reducing and/or avoiding traffic congestion, and ensuring smooth hand-overs. The requirements for traffic balancing in 5G may be understood to emerge due to potential coverage issues, throughput and latency limitations in the 4G leg of 5G, in a Non-Stand Alone (NSA) implementation. Service level enhancements may be understood to also require effective utilization of 5G Quality of Service Indicator (5QI) architecture in 5G networks.

It is well known that approaches relying on ML may enable to improve traffic management in a large network by bringing in data based analysis, efficiency in detection and/or prediction, and scalability in automated solutioning. ML approaches for traffic management may be broadly categorized as belonging to a (i) predictive approach, that is, proactive approach, and to (ii) anomaly detection, that is, to a reactive approach. The outcome of these approaches may be understood to involve moving eligible user equipments (UEs) from a problem cell to a neighboring cell with available resources, and/or identifying the root cause of the problem to solve the traffic management. The handovers, that is, moving eligible UEs, may be intra or inter Radio Access Technology (RAT) in the case of 5G networks. A typical flow of an ML based solution is shown in FIG. 1(a). FIG. 1 (a) is a schematic block diagram of an ML solution for network traffic management. In step 1, a prediction and/or a detection of cells that may be likely to degrade may be performed. In step 2, handover (HO) attempts and actuations may be performed based on the predictions. In step 3, the effect of the actuations may be monitored, which may lead to performing additional HO attempts and actuations, or reverting back to a previous configuration, and/or to perform new predictions and/or detections.

There may be different ways to deploy a 5G network, with or without interworking with Long Term Evolution (LTE). 5G implementations may be of 2 types: Non-Stand Alone (NSA) and Stand Alone (SA), and involve multi-RAT components, especially, the NSA architecture. FIG. 1b is a schematic diagram showing the implementation of some 4G and 5G architectures, particularly, of the 4G, 5G-NSA and 5G-SA architectures. In principle, NR and LTE may be deployed without any interworking, denoted by NR stand-alone (SA) operation, that is, an eNB may be connected to an EPC and a gNB in NR may be connected to a 5G core network (5GC), with no interconnection between the two, as depicted, respectively, in Option 1 and Option 2 in the figure. Option 1, the panel in FIG. 1(b) most to the left, depicts a 4G architecture, wherein an LTE base station 4 is connected to an Evolved Packet Core (EPC) core network 5, and may provide service to a User Equipment (UE) 6. Option 2, the panel in FIG. 1(b) most to the right, depicts an SA 5G architecture, wherein an NR base station 7 is connected to an 5G Core (5GC) core network 8, and may provide service to a UE 9. Option 3x, in the center panel in FIG. 1(b), depicts an NSA 5G architecture, wherein an LTE base station 4 an NR base station 7 are connected and to an EPC core network 5, and may provide service to a UE 10. In FIG. 1(b), a continuous line between the entities depicted represents the user plane, whereas the dashed line represents the control plane. In such a deployment, dual connectivity between NR and LTE may be applied with LTE as the master and NR as the secondary node. The RAN node (gNB) supporting NR 7, may not have a control plane connection to the EPC core network, instead it may rely on the LTE as master node (MeNB) 4. This is also referred to as NSA NR. It may be noted that in this case, the functionality of an NR cell may be limited and may be used for connected mode UEs as a booster and/or as a diversity leg. Dual connectivity with two RANs, e.g., Evolved Universal Terrestrial Radio Access Network (E-UTRAN) and NR, may be achieved in several ways. A variant may be MR-DC with EPC (EN-DC), which may be understood as Multi-Radio Dual Connectivity (MR-DC), where the CN may be EPC, and where an eNB may act as Master Node (MN) and an en-gNB may act as Secondary Node (SN).

In addition to the architecture, Dynamic Spectrum Sharing (DSS) may allow instantaneous sharing of spectral resources between 4G and 5G both NSA and SA implements, as schematically shown in FIG. 2. In FIG. 2, the horizontal axis is the transmit time interval (TTI) in ms, and the vertical axis is indicative of Physical Resource Block (PRB) utilization, that is, the percent of spectrum allocated between 4G and 5G, representing traffic. As depicted in FIG. 2, the resources allocated to 4G or 5G communications may dynamically vary along time, based on e.g., existing demand.

In spite of the advantages provided by using ML approaches within the context of a communications network, and especially in spite of the advantages brought by 5G technology, existing ML methods may still result in poor traffic management in a communications network.

### SUMMARY

As part of the development of embodiments herein, one or more problems with the existing technology will first be identified and discussed.

Existing methods in traffic management may address typical congestion level, radio condition etc. However, existing methods do not address managing traffic considering multi-RAT challenges raised by 5G NSA, SA architecture implementations, or the spectrum sharing components that may be introduced due to 5G technology, or address 5QI based ML approaches. Particularly, existing methods do not address the challenges of the multi-RAT combinations that may arise due to NSA and SA modes of 5G, UE types, Evolved Universal Terrestrial Radio Access NR Dual Connectivity (ENDC), KPIs at the 5QI level, and ML solutions for DSS. These combinations, both on the network side and the UE equipment's side in the field together create availability, assurance and optimization challenges. The challenges of optimization and/or service-assurance to UEs to be carried-out and/or maintained in such scenarios is not covered by existing methods. Therefore, the traffic management problem is not yet solved fully. Furthermore, existing methods do not address ML approaches for DSS implementations of 5G, 5QI or Quality of Service (QoS) specific approaches.

Embodiments herein may be understood propose to address the above-described challenges in network traffic management through ML.

It is therefore an object of embodiments herein to improve the handling of one or more ML models in a communications system.

According to a first aspect of embodiments herein, the object is achieved by a computer-implemented method, performed by a first node. The method is for handling one or more ML models. The first node operates in a communications system. The first node determines, using ML, one or more ML models of an indicator of operation of the communications system. The determining is based on a respective operation mode of RAT used by a respective set of nodes wherefrom respective data has been collected to train, or infer, a respective ML model of the one or more ML models. The first node then provides a respective indication of the determined one or more ML models to a second node operating in the communications system.

According to a second aspect of embodiments herein, the object is achieved by a computer-implemented method, performed by the second node. The method is for handling the one or more ML models. The second node operates in the communications system. The second node receives, from the first node operating in the communications system, the respective indication of the one or more ML models of the indicator of operation of the communications system. The one or more ML models are based on the respective operation mode of RAT, used by the respective set of nodes wherefrom the respective data have been collected to train, or infer, the respective ML model of the one or more ML models. The second node then performs one or more actions based on the received respective indication of the one or more ML models.

According to a third aspect of embodiments herein, the object is achieved by the first node. The first node may be understood to be for handling the one or more ML models. The first node is configured to operate in the communications system. The first node is further configured to determine, using ML, the one or more ML models of the indicator of operation of the communications system. The determining is configured to be based on the respective operation mode of RAT configured to be used by the respective set of nodes wherefrom the respective data is configured to have been collected to train, or infer, the respective ML model of the one or more ML models. The first node is also configured to provide the respective indication of the one or more ML models configured to be determined to the second node configured to operate in the communications system.

According to a fourth aspect of embodiments herein, the object is achieved by the second node. The second node may be understood to be for handling the one or more ML models. The second node is configured to operate in the communications system. The second node is configured to receive, from the first node configured to operate in the communications system, the respective indication. The respective indication is of the one or more ML models of the indicator of operation of the communications system. The one or more ML models are configured to be based on the respective operation mode of RAT configured to be used by the respective set of nodes wherefrom the respective data is configured to have been collected to train, or infer, the respective ML model of the the one or more ML models. The second node is also configured to perform the one or more actions based on the respective indication of the one or more ML models configured to be received.

According to a fifth aspect of embodiments herein, the object is achieved by a computer program, comprising instructions which, when executed on at least one processing circuitry, cause the at least one processing circuitry to carry out the method performed by the first node.

According to a sixth aspect of embodiments herein, the object is achieved by a computer-readable storage medium, having stored thereon the computer program, comprising instructions which, when executed on at least one processing circuitry, cause the at least one processing circuitry to carry out the method performed by the first node.

According to a seventh aspect of embodiments herein, the object is achieved by a computer program, comprising instructions which, when executed on at least one processing circuitry, cause the at least one processing circuitry to carry out the method performed by the second node.

According to an eighth aspect of embodiments herein, the object is achieved by a computer-readable storage medium, having stored thereon the computer program, comprising instructions which, when executed on at least one processing circuitry, cause the at least one processing circuitry to carry out the method performed by the second node.

By determining the one or more ML models of the indicator of operation of the communications system, the first node may be enabled to build ML models that may more accurately predict or detect the behavior of the indicator of the operation of the communications system in each of the different operation modes of RAT. This may be understood to be by the one or more ML models being tailored to each of the different operation modes of RAT. This may in turn enable to lead to insights on the operation of the communications system, which may in turn enable to perform aid traffic management activities such as congestion handling through alerts, problem management system, e.g., using tickets, or through automated HO actuations. For example, proactive traffic balancing methods may comprise predicting KPI degradation at a cell level using KPIs indicative of cell spectrum utilization, coverage, and accessibility features in advance of H hours. Such predictions may in turn be used to initiate handover actuations so that devices may be enabled to be served by a neighboring cell with available resources. A holistic viewpoint of degradation may be enabled by considering multiple KPI in the proactive, or reactive, ML models.

By providing the respective indication to the second node, the first node may enable the second node to then use the ML models to more accurately predict or detect the behavior of the indicator of the operation of the communications system in any, or each, of the different operation modes of RAT, by being tailored to any, or each, of the different operation modes of RAT. This may in turn enable to lead to insights on the operation of the communications system, which may in turn enable the second node to perform traffic management activities.

By receiving the respective indication from the first node, the second node may be enabled to then use the one or more ML models to more accurately predict or detect the behavior of the indicator of the operation of the communications system in any, or each, of the different operation modes of RAT, by being tailored to each of the different operation modes of RAT. This may in turn enable to lead to insights on the operation of the communications system, which may in turn enable the second node to perform traffic management activities, such as congestion handling through alerts, problem management system, e.g., using tickets, or through automated HO actuations.

By performing the one or more actions, the second node may then be enabled to modify the configuration, such as e.g., handover parameters, tilt changes and power configuration changes, of the communication system, to improve the performance of the communications system, e.g., traffic balancing, energy efficiency improvement, spectrum efficiency improvement, etc., and manage the indicator of performance of the communications system, so that the performance of the communications system may be improved.

For example, the 5G NSA, SA and DSS implementations may bring in challenges and offerings in terms of network utilization and capabilities. Embodiments herein may enable to analyze 5QI and/or QoS KPI degradation in NSA, SA and/or LTE for a finer viewpoint of service level performance and better user experience.

### BRIEF DESCRIPTION OF THE DRAWINGS

Examples of embodiments herein are described in more detail with reference to the accompanying drawings, according to the following description.

FIG. 1 is a schematic diagram illustrating in panel (a) an ML approach for network traffic management, and in panel (b) 4G (Option 1), 5G-NSA (Option 3x) and 5G-SA (Option 2) architectures, according to existing methods.

FIG. 2 is a schematic diagram illustrating dynamic spectrum sharing between a 5G and a 4G RAT, according to existing methods.

FIG. 3 is a schematic diagram illustrating two non-limiting examples of a communications system, according to embodiments herein.

FIG. 4 is a flowchart depicting a method in a first node, according to embodiments herein.

FIG. 5 is a flowchart depicting a method in a second node, according to embodiments herein.

FIG. 6 is a schematic diagram depicting particular aspects of a non-limiting example of the method performed by the first node, according to embodiments herein.

FIG. 7 is a schematic diagram depicting particular aspects of another non-limiting example of the method performed by the first node, according to embodiments herein.

FIG. 8 is a schematic diagram depicting particular aspects of a further non-limiting example of the method performed by the first node, according to embodiments herein.

FIG. 9 is a schematic diagram depicting particular aspects of an additional non-limiting example of the method performed by the first node, according to embodiments herein.

FIG. 10 is a schematic block diagram illustrating an embodiment of a first node, according to embodiments herein.

FIG. 11 is a schematic block diagram illustrating an embodiment of a second node, according to embodiments herein.

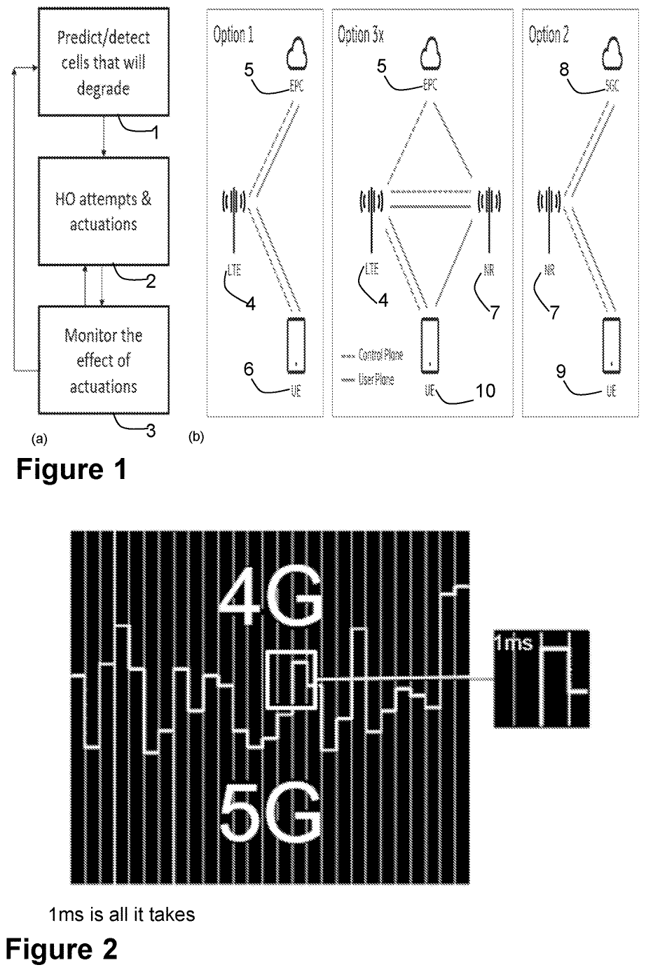

### DETAILED DESCRIPTION

Certain aspects of the present disclosure and their embodiments address the challenges identified in the Background and Summary sections with the existing methods and provide solutions to the challenges discussed.

Embodiments herein may be understood to relate to a system and approach for ML based methods for traffic management, particularly 5G traffic management.

Embodiments herein may provide a method for identifying cell usage type, also referred to herein as “operation mode”, e.g., pure-LTE, ENDC-LTE, ENDC-NR, DSS, pure-NR, which may arise in NSA and SA implementations of 5G architecture. This may be extended to include Carrier Aggregation (CA) cells in each of LTE/NR.

Embodiments herein may therefore enable cell usage type specific data processing and ML use cases to be defined for technology/feature capability in the network, leading to traffic management.

Particular embodiments herein may enable to generate features for an ML model based on cell usage type or operation mode.

Some embodiments herein may enable to generate ML models and insights based on cell usage type or operation mode.

Some embodiments herein may enable automated actuations for traffic balancing.

Embodiments herein may provide a generic 5G KPI degradation ML framework leading to traffic management activities.

The same may be extended to LTE, since embodiments herein may address 5G-NSA.

Some embodiments herein may enable 5G traffic balancing and monitoring through HO. HO thresholds, cell individual offset and/or hysteresis may be considered for effecting HO.

Embodiments herein may provide an approach to provide a framework for ML use cases, such as traffic balancing, at QoS and 5QI level in 5G, for better user experience.

Some of the embodiments contemplated will now be described more fully hereinafter with reference to the accompanying drawings, in which examples are shown. In this section, the embodiments herein will be illustrated in more detail by a number of exemplary embodiments. Other embodiments, however, are contained within the scope of the subject matter disclosed herein. The disclosed subject matter should not be construed as limited to only the embodiments set forth herein; rather, these embodiments are provided by way of example to convey the scope of the subject matter to those skilled in the art. It should be noted that the exemplary embodiments herein are not mutually exclusive. Components from one embodiment may be tacitly assumed to be present in another embodiment and it will be obvious to a person skilled in the art how those components may be used in the other exemplary embodiments.

Several embodiments and examples are comprised herein. It should be noted that the embodiments and/or examples herein are not mutually exclusive. Components from one embodiment or example may be tacitly assumed to be present in another embodiment or example and it will be obvious to a person skilled in the art how those components may be used in the other exemplary embodiments and/or examples.

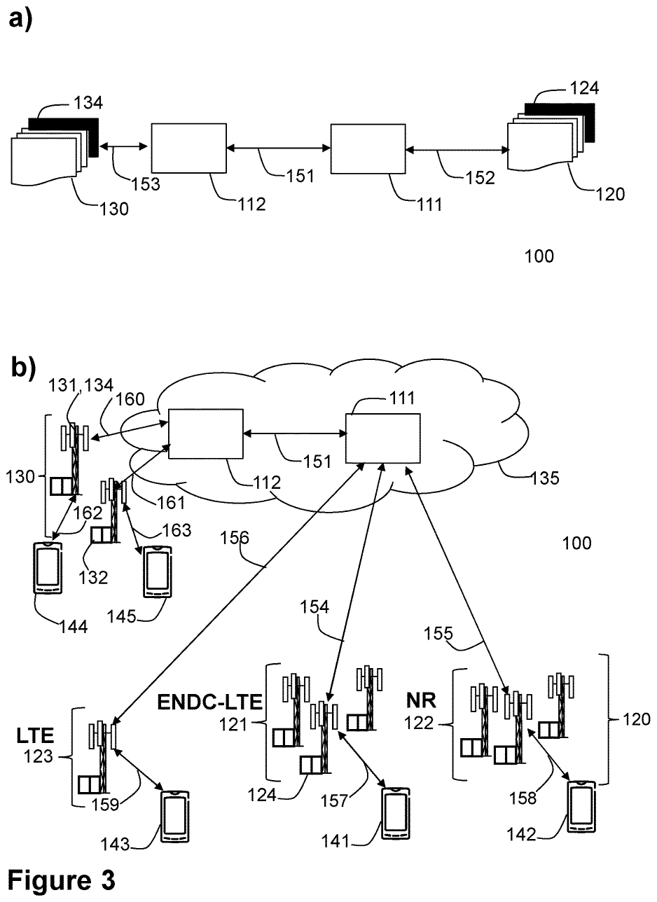

FIG. 3 depicts two non-limiting examples, in panels “a” and “b”, respectively, of a communications system 100, in which embodiments herein may be implemented. In some example implementations, such as that depicted in the non-limiting example of FIG. 3a), the communications system 100 may be a computer network. In other example implementations, such as that depicted in the non-limiting example of FIG. 3b), the communications system 100 may be implemented in a telecommunications system, sometimes also referred to as a cellular radio system, cellular network or wireless communications system. In some examples, the telecommunications system may comprise network nodes which may serve receiving nodes, such as wireless devices, with serving beams.

In some examples, the telecommunications system may for example be a network such as 5G system, or Next Gen network, such as a SA with NR, Non-SA with NR and ENDC-NR. The telecommunications system may also, or alternatively, support other technologies, such as an LTE network, e.g. LTE Frequency Division Duplex (FDD), LTE Time Division Duplex (TDD), LTE Half-Duplex Frequency Division Duplex (HD-FDD), LTE operating in an unlicensed band, as pure LTE, or SA operation with LTE, ENDC-LTE. The telecommunications system may also support other technologies, such as Wideband Code Division Multiple Access (WCDMA), Universal Terrestrial Radio Access (UTRA) TDD, GSM/Enhanced Data Rate for GSM Evolution (EDGE) Radio Access Network (GERAN) network, Ultra-Mobile Broadband (UMB), EDGE network, network comprising of any combination of Radio Access Technologies (RATs) such as e.g. Multi-Standard Radio (MSR) base stations, multi-RAT base stations etc., any 3rd Generation Partnership Project (3GPP) cellular network, Wireless Local Area Network/s (WLAN) or WiFi network/s, Worldwide Interoperability for Microwave Access (WiMax), IEEE 802.15.4-based low-power short-range networks such as IPv6 over Low-Power Wireless Personal Area Networks (6LowPAN), Zigbee, Z-Wave, Bluetooth Low Energy (BLE), or any cellular network or system.

The telecommunications system may also, or alternatively, support Carrier Aggregation (CA) and dynamic spectrum sharing (DSS) between a first RAT and a second RAT.

The communications system 100 comprises nodes, whereof a first node 111 and a second node 112 are depicted in FIG. 3. In some examples, which are not depicted in FIG. 3, the first node 111 and the same node 112 may be co-located or be the same node.

The communications system 100 may comprise additional nodes, such as a plurality of sets nodes 120. The plurality of sets of nodes 120 may comprise, as in the non-limiting example depicted in panel b) of FIG. 3, of a first set of nodes 121, a second set of nodes 122 and a third set of nodes 122. The plurality of sets of nodes 120 may comprise a node 124. The first set of nodes 121 and the second set of nodes 122 are each represented in panel b) of FIG. 3, as comprising three nodes. The third set of nodes 123 is represented as comprising a single node. This may be understood to be non-limiting and for illustrative purposes only. The communications system 100 may further comprise a plurality of second sets of nodes 130. The plurality of second sets of nodes 130 may comprise, in the non-limiting example depicted in panel b) of FIG. 3, a first second set of nodes 131, and a second second set of nodes 132. The plurality of second sets of nodes 130 may comprise a node 134, as depicted in panel a) of FIG. 3. In the non-limiting example of FIG. 3, each of the first second set of nodes 131 and the second second set of nodes 132 is depicted as comprising a single node. However, it may be understood that this is for illustrative purposes only, and that each respective set of nodes 121, 122, 123 and each respective second set of nodes 131, 132 may comprise fewer or further additional nodes in other examples.

Any of the first node 111 and the second node 112 may be understood, respectively, as a first computer system or server, and a second computer system or server. Any of the first node 111 and the second node 112 may be implemented as a standalone server in e.g., a host computer in the cloud 135, as depicted in the non-limiting example of FIG. 3b). In other examples, any of the first node 111 and the second node 112 may be a distributed node or distributed server, such as a virtual node in the cloud 135, and may perform some of its respective functions locally, e.g., by a client manager, and some of its functions in the cloud 135, by e.g., a server manager. In other examples, any of the first node 111 and the second node 112 may perform its functions entirely on the cloud 135, or partially, in collaboration or collocated with a radio network node. Yet in other examples, any of the first node 111 and the second node 112 may also be implemented as processing resources in a server farm. Any of the first node 111 and the second node 112 may be under the ownership or control of a service provider or may be operated by the service provider or on behalf of the service provider.

Any of the first node 111, and the second node 112 may be understood to have a capability to perform machine-implemented learning procedures, which may be also referred to as “machine learning” (ML). The ML procedures may be proactive or reactive in nature and may involve, e.g., supervised/unsupervised/RL, algorithms to be able to predict or detect degradations in cells. The ML procedures may comprise e.g., detecting or predicting insights such as anomalies, forecasts, degradation conditions etc.

In some embodiments, any of the first node 111 and the second node 112 may be a core network node, such as, e.g., a network data analytics function (NWDAF), a Serving General Packet Radio Service Support Node (SGSN), a Mobility Management Entity (MME), a positioning node, a coordinating node, a Self-Optimizing/Organizing Network (SON) node, a Minimization of Drive Test (MDT) node, etc . . . . In 5G, for example, any of the first node 111 and the second node 112 may be located in the Operations Support Systems (OSS).

In other examples not depicted in FIG. 3, any of the first node 111 and the second node 112 may be a radio network node.

Any of the nodes in the the plurality of sets of nodes 120 and any of the nodes in the plurality of second sets of nodes 130 may be a core network node, e.g., another core network node, or a radio network node. A radio network node may be, e.g., comprised in a Radio Access Network of the telecommunications system. That is, the radio network node may be a transmission point such as a radio base station, for example a gNB, an eNB, or any other network node with similar features capable of serving a wireless device, such as a user equipment or a machine type communication device, in the communications system 100. In typical examples, the radio network node may be a base station, such as a gNB or an eNB. In other examples, the radio network node may be a distributed node, such as a virtual node in the cloud 135, and may perform its functions entirely on the cloud 135, or partially, in collaboration with a radio network node.

The telecommunications system may cover a geographical area, which in some embodiments may be divided into cell areas, wherein each cell area may be served by a radio network node, although, one radio network node may serve one or several cells. In the example of FIG. 3, the cells are not depicted to simplify the figure. The network node may be of different classes, such as, e.g., macro eNodeB, home eNodeB or pico base station, based on transmission power and thereby also cell size. In some examples, the network node may serve receiving nodes with serving beams.

Any of the first node 111, the second node 112, any of the nodes in the the plurality of sets of nodes 120 and any of the nodes in the plurality of second sets of nodes 130 comprised in the communications system 100 may support one or several communication technologies, and its name may depend on the technology and terminology used. Any of the radio network nodes that may be comprised in the communications system 100 may be directly connected to one or more core networks.

A plurality of wireless devices may be comprised in the wireless communication network 100, whereof a first device 141, a second device 142, a third device 143, a fourth device 144, and a fifth device 145 are depicted in the non-limiting example of panel b) in FIG. 3. This may be understood to be non-limiting and for illustrative purposes only. Further or fewer wireless devices may be comprised in the communications system 100. Any wireless device comprised in the wireless communications system 100 may be a wireless communication device such as a 5G UE, or a UE, which may also be known as e.g., mobile terminal, wireless terminal and/or mobile station, a Customer Premises Equipment (CPE) a mobile telephone, cellular telephone, or laptop with wireless capability, just to mention some further examples. Any of the wireless devices comprised in the communications system 100 may be, for example, portable, pocket-storable, hand-held, computer-comprised, or a vehicle-mounted mobile device, enabled to communicate voice and/or data, via the RAN, with another entity, such as a server, a laptop, a Personal Digital Assistant (PDA), or a tablet, Machine-to-Machine (M2M) device, device equipped with a wireless interface, such as a printer or a file storage device, modem, or any other radio network unit capable of communicating over a radio link in a communications system. Any wireless device comprised in the communications system 100 is enabled to communicate wirelessly in the communications system 100. The communication may be performed e.g., via a RAN, and possibly the one or more core networks, which may be comprised within the wireless communications system 100.

As depicted in the non-limiting example of panel b) of FIG. 3, in examples wherein any of the first node 111 and the second node 112 may be core network nodes, any of the first node 111, and the second node 112 may be located in the cloud 135 and communicate with one or more wireless devices via a respective radio network node in any of the plurality of sets of nodes 120 and the plurality of second sets of nodes 130. In the particular non-limiting example of panel b) in FIG. 3, the first node 111 communicates with the first device 141 via a node 124 in the first set of nodes 121, the first node 111 communicates with the second device 142 via one of the nodes in the second set of nodes 122, the first node 111 communicates with the third device 143 via a node in the third set of nodes 123, the second node 112 communications with the fourth device 144 via a node in the first second set of nodes 131, and the second node 112 communicates with the fifth device 145 via a node in the second second set of nodes 132.

The first node 111 may be configured to communicate within the communications system 100 with second node 112 over a first link 151, e.g., a radio link. or a wired link. The first node 111 may be configured to communicate within the communications system 100 with any of the nodes in the plurality of sets of nodes 120 over a respective second link 152, e.g., a radio link. or a wired link. The second node 112 may be configured to communicate within the communications system 100 with any of the nodes in the plurality of second sets of nodes 130 over a respective third link 153, e.g., a radio link. or a wired link. The first node 111 may be configured to communicate within the communications system 100 with any of the nodes in the first set of nodes 121 over a respective fourth link 154, e.g., a radio link. or a wired link. The first node 111 may be configured to communicate within the communications system 100 with any of the nodes in the second set of nodes 122 over a respective fifth link 155, e.g., a radio link or a wired link. The first node 111 may be configured to communicate within the communications system 100 with any of the nodes in the third set of nodes 123 over a respective sixth link 156, e.g., a radio link. or a wired link. Any of the nodes in the first set of nodes 121 may be configured to communicate within the communications system 100 with the first device 141 over a seventh link 157, e.g., a radio link. or a wired link. Any of the nodes in the second set of nodes 122 may be configured to communicate within the communications system 100 with the second device 142 over a respective eighth link 158, e.g., a radio link. or a wired link. Any of the nodes in the third set of nodes 123 may be configured to communicate within the communications system 100 with the third device 143 over a respective ninth link 159, e.g., a radio link or a wired link. The second node 112 may be configured to communicate within the communications system 100 with any of the nodes in the first second set of nodes 131 over a respective tenth link 160, e.g., a radio link. or a wired link. The second node 112 may be configured to communicate within the communications system 100 with any of the nodes in the second second set of nodes 132 over a respective eleventh link 161, e.g., a radio link. or a wired link. Any of the nodes in the first second set of nodes 131 may be configured to communicate within the communications system 100 with the fourth device 144 over a twelfth link 162, e.g., a radio link. or a wired link. Any of the nodes in the second second set of nodes 132 may be configured to communicate within the communications system 100 with the fifth device 145 over a respective thirteenth link 163, e.g., a radio link. or a wired link.

Any of the links described in the previous paragraph may be a direct link or may be comprised of a plurality of individual links, wherein it may go via one or more computer systems or one or more core networks in the communications system 100, which are not depicted in FIG. 3, or it may go via an optional intermediate network. The intermediate network may be one of, or a combination of more than one of, a public, private or hosted network; the intermediate network, if any, may be a backbone network or the Internet; in particular, the intermediate network may comprise two or more sub-networks, which is not shown in FIG. 3.

In general, the usage of “first”, “second”, “third”, “fourth”, “fifth”, “sixth”, “seventh”, “eighth”, “ninth”, “tenth”, “eleventh”, “twelfth” and/or “thirteenth” herein may be understood to be an arbitrary way to denote different elements or entities, and may be understood to not confer a cumulative or chronological character to the nouns they modify.

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

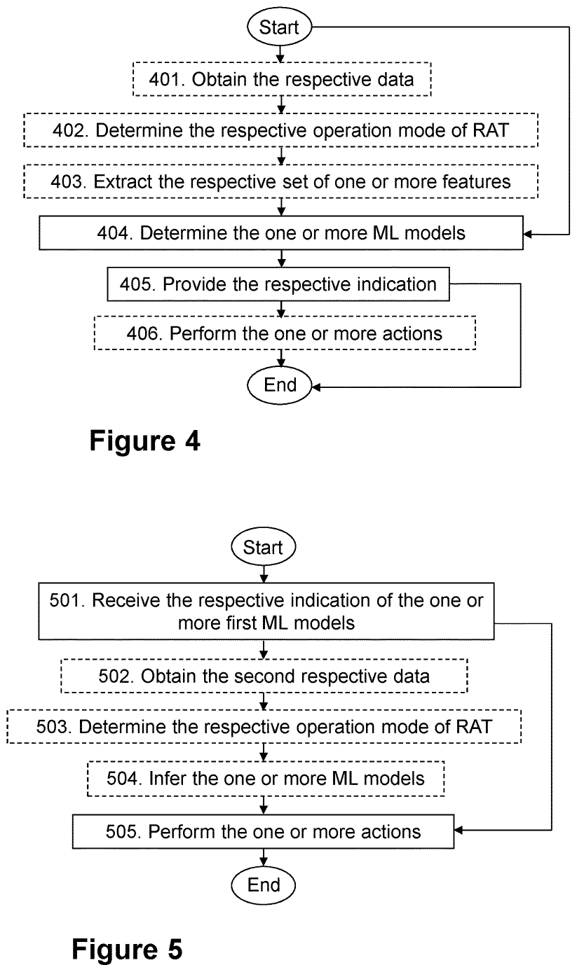

Embodiments of a computer-implemented method, performed by the first node 111, will now be described with reference to the flowchart depicted in FIG. 4. The method is for handling one or more ML models. The first node 111 operates in the communications system 100.

In some embodiments, the communications system 100 may comprise one of: i) a 5G architecture, and ii) a 4G architecture.

Several embodiments are comprised herein. In some embodiments all the actions may be performed. In some embodiments, some actions may be optional. In FIG. 4, optional actions are indicated with dashed lines. It should be noted that the examples herein are not mutually exclusive. Components from one embodiment may be tacitly assumed to be present in another embodiment and it will be obvious to a person skilled in the art how those components may be used in the other exemplary embodiments. One or more embodiments may be combined, where applicable. All possible combinations are not described to simplify the description.

### Action 401

In this Action 401, the first node 111 may obtain respective data from a respective set of nodes 121, 122, 123. The data may be collected from the plurality of sets of nodes 120.

The data may comprise at least one of: i) first data comprising information about a respective site where the data was collected, ii) second data indicating performance management (PM) data, iii) third data indicting fault management data, iv) fourth data indicating configuration management data, v) fifth data indicating call trace records, and vi) sixth data comprising historical data.

The first data comprising information about the respective site may comprise information regarding a cell, such as the cell name, cell identifier, its operating frequency and bandwidth, modes of operation, the associated sites, the location of site, carrier aggregation information, etc.

The second data indicating PM data may comprise counters indicative of a quality of the network, that is, of the communications system 100, system characteristics that may define the performance of a cell, modulation scheme used, channel descriptors, hand over attempts, layer of collection of data, etc for every reporting output period (ROP) which in turn may be used to calculate Key performance indicators (KPI), of the cells. Examples may be such as, but not limited to, accessibility, retainability, mobility, integrity, availability etc. These KPIs may give the perception of performance of the cells. Some example KPIs may be, but may not be limited to, latency, throughput, Random Access Channel (RACH) success rate, Signal to Interference and Noise Ratio (SINR), Channel Quality Indicator (CQI), Modulation and Coding Scheme (MCS), PathLoss, etc.

The third data indicating fault management data may comprise e.g., notifications of alarms, cell and/or sites associated with the alarms and/or faults, start and end time of fault occurrence, potential indicators of fault type, category, alarm criticality, etc.

The fourth data indicating configuration management data may comprise HO offsets, hysteresis, cell individual offset, or any other cell and/or antenna parameters.

The fifth data indicating call trace records may comprise one or more sequence of events that may be captured on a real time basis and may be representative of a flow of events at a device or node end. Examples may comprise a sequence of events such as, Radio Resource Control (RRC) connection requests-RRC connection setup-RRC connection success RRC reconfiguration complete.

The sixth data comprising historical data may comprise historical data from any combination of the above five data sets.

Obtaining in this Action 401 may comprise receiving, directly or indirectly, from the plurality of sets of nodes 120, and or retrieving the data from a memory storage.

By obtaining respective data from the respective set of nodes 121, 122, 123 in this Action 401, the first node 111 may then be enabled to use the obtained data to ultimately determine one or more ML models to make predictions and/or detections on an indicator of operation of the communications system 100, as will be explained in Action 404. The insights from the ML based predictions and/or detections of the indicator of operation, e.g., RAN KPI degradation predictions, may in turn enable to perform traffic management activities, such as congestion handling, through alerts, problem management system, e.g., using tickets, or through automated HO actuations. Insights may be understood to refer to a collection of information, individual or aggregated, obtained from analysis using an ML model, which may help to make decisions or be fed to a downstream task, or to another node, such as the second node 112, for further actions.

### Action 402

In embodiments herein, the insights from the architecture of the communications system 100 may be segregated into different components based on the cell usage type, or what may be referred to herein as the operation mode of RAT. For example, for a 5G architecture, the operation mode of RAT may be LTE, NR and DSS.

In this Action 402, the first node 111 may determine a respective operation mode of RAT of each respective set of nodes 121, 122, 123 in the plurality of sets of nodes 120. This determination may be performed, such that a respective set of data may be selected for training, and/or inferencing from, a respective ML model for a respective operation mode of RAT. In other words, embodiments herein may aim at building separate, or different, ML models for different modes of operation of RAT, since each of these may behave differently, e.g., a particular variable may affect one mode of operation of RAT in a different way than another, so that the same ML model may not be best suited for each mode of operation of RAT. By building separate ML models, separately for different modes of operation of RAT, each ML model may have a higher accuracy in predicting and/or detecting the target indicator.

In some embodiments, the respective operation mode of RAT may comprise at least one of: i) SA operation with one RAT, ii) Non-SA with a first RAT, iii) Non-SA with a second RAT, iv) spectrum sharing, e.g., dynamic spectrum sharing (DSS), between the first RAT and the second RAT, and v) Carrier Aggregation (CA).

In some embodiments, the respective operation mode of RAT may comprise at least one of: (i) SA operation with one RAT, where in the one RAT is NR, e.g., excluding DSS, (ii) SA operation with DSS, wherein spectrum is shared between NR UEs and pure LTE or ENDC-LTE or ENDC-NR UEs, and (iii) SA operation with CA. The ML based embodiments may also be extended for LTE, as the embodiments may be understood to address 5G-NSA architecture as well.

Separate ML models may be built taking into consideration the operation of the level of service in order to have a finer viewpoint of service level performance and better user experience. The operation of the level of service may be understood to comprise 5QI and QoS ML approaches, e.g., in NSA, SA, LTE. 5QI may be understood to refer to 5G QoS characteristics such as, e.g., resource type, priority level, packet delay budget, packet error rate, etc. It may be understood to represent service requirements and other QoS characteristics in a 5G system.

The determining in this Action 402 may enable to categorize a cell in one of the of operation modes of RAT, e.g., pure LTE, ENDC-LTE, ENDC-NR, DSS in NSA, etc . . . The same approach may be extended to include CA cells in each of LTE and/or NR.

The determining in this Action 402 may be understood as calculating, deriving, estimating or similar.

To segregate the insights based on cell usage type, also referred to as mode of operation, the first node 111 may perform a static classification of cell usage type as, e.g., LTE or ENDC-NR or DSS, based on the obtained first data, that is, the site level information. Within LTE, the first node 111 may dynamically identify cells based on usage type as: a) pure LTE, namely, cells which may not support NR, e.g., due to no users and/or no available upgrade, and b) ENDC-LTE cells which may support NR, e.g., due to latched ENDC users.

For example, Flex features may be considered. Flex counters may be understood as counters that may be understood to have been introduced for NSA implementation of 5G to capture the behavior of a cell for the ENDC UEs. Examples may comprise flex counters of hand overs, data volume, both Uplink (UL), Downlink (DL), and other counters from which it may be possible to derive mobility, reliability, accessibility KPIs of ENDC UEs. When new UE categories may be introduced with different characteristics, for example ENDC UEs, KPIs may show higher or lower values. Flex counter features, when in use, may then be used to report the usage patterns of ENDC UEs, when attached.

The features considered for identifying, e.g., ENDC-LTE, ENDC-NR, SA and DSS may comprise, e.g., RAN features, such as KPIs, and their historical values, relating to accessibility, reliability, mobility, integrity etc. To identify an LTE cell to be operating or serving only LTE users, as against its mode of operation while serving ENDC UEs, the RAN features may be used along with the ENDC equivalent of those features, e.g., KPIs derived from flex counters.

For identifying cells in NR, with or without DSS mode, and LTE, with or without DSS mode, features from the first data from the site may be used.

In some embodiments, a same node 124 in the plurality of sets of nodes 120 may operate with different operation modes of RAT at different respective periods of time and may yield respective subsets of data for each respective operation mode of RAT of the different operations modes of RAT. In some of such embodiments, the determining in this Action 402 of the respective operation mode of RAT of each respective set of nodes 121, 122, 123 may be performed for a respective period of time. That is, the same node 124 may switch from one operation mode to another, and the first node 111 may determine different operation modes for the same node 124, each of the different operation modes being used by the same node 124 on a different period of time.

According to the foregoing, in this Action 402, the first node 111 may determine the mode of operation or cell usage type identification, based on the past N hours of historical data, for example, by use of flex counters.

By in this Action 402, determining the respective operation mode of RAT of each respective set of nodes 121, 122, 123 in the plurality of sets of nodes 120, the first node 111 may be enabled to identify cell usage type, e.g., pure-LTE, ENDC-LTE, ENDC-NR, DSS, pure-NR, that may, for example arise in NSA and SA implementations of 5G architecture. The above approach may be extended to include other operation modes of RAT or cell usage types that may emerge due to deployment configurations namely, CA cells in LTE and NR by considering CA Performance Management (PM) counters and KPIs.

This may then enable processing of operation mode of RAT, or cell usage type, specific data and ML use cases to be defined for technology and/or feature capability in the communications system 100, leading to traffic management. The analysis based on operation of the level of service may be understood to enable to utilize 5QI architecture through ML models for enhancing user experience.

By, in this Action 402, determining the respective operation mode of RAT of each respective set of nodes 121, 122, 123 in the plurality of sets of nodes 120, the first node 111 may be also enabled to then provide the inputs to generate features for building one or more ML models based on cell usage type, or operation mode of RAT. This may in turn enable to generate ML models and insights based on cell usage type or operation mode of RAT, which may ultimately enable automated actuations for traffic balancing.

### Action 403

In some embodiments, a respective set of data may be selected, e.g., by the first node 111, for training, or inferencing, a respective ML model for a respective operation mode of RAT. The respective set of data may have been collected from a respective set of nodes 121, 122, 123 using the respective operation mode of RAT, e.g., during a certain time period.

In some of such embodiments, in this Action 403, the first node 111 may extract, out of the collected data, a respective set of one or more features from each respective set of data in order to train, or infer, the respective ML model.

Embodiments herein may use an exhaustive set, e.g., a list, of input features for any ML model for predicting or detecting an indicator of operation of the communications system 100, for example, KPI degradation. The list may be understood to presume the operation mode of RAT, or cell usage type identification performed in Action 402, as a precursor. The features may comprise the following features.

A first group of features may comprise NSA features for pure-LTE, comprising KPIs relating, but not limited, to: packet loss, Hybrid Automatic Repeat Request (HARQ) for various modulation schemes, coverage, latency, CQI, SINR, utilization of common and/or shared channels and physical resource blocks, Block Error Rate (BLER), traffic volume, pathloss, cell downtime, throughput, rank distribution, spectral efficiency, connected users, accessibility, handover KPIs, Operations Support System (OSS), hour, minute (min), day of week, CA throughput and/or volume. The first group of features may also comprise features for pure LTE.

A second group of features may comprise NSA features for ENDC-LTE, comprising KPIs relating, but not limited, to: pure LTE KPIs and ENDC features, such as ENDC attempts, flex payload, flex throughput, differentiated throughput, B1 reports, B1 trigger rate, OSS hour, min, day of week, Flex-CA throughput and/or volume.

A third group of features may comprise NSA Features for NR-NSA, comprising KPIs relating, but not limited, to: connected and active users, latency, cell downtime, CQI, volume, packet loss, transmission ratio, Resource Block Symbol Utilization (RBSymbol) utilization, modulation, throughput, BLER, RACH success rate, Physical Downlink Control Channel (PDCCH) and/or Physical Downlink Shared Channel (PDSCH) utilization, retainability, SINR, retransmission rate, Uplink (UL) Received Signal Strength Indicator (RSSI), Multiple Input Multiple Output (MIMO) ranks, OSS hour, min, day of week, CA throughput/volume. The third group of features may also comprise features for NR-NSA, QoS and/or QoS Class Identifier (QCI) level KPIs included.

A fourth group of features may comprise NSA Features for DSS, comprising KPis relating, but not limited, to pure-LTE+DSS utilization Ultra WideBand (UWB). The fourth group of features may also comprise features for DSS, QoS and/or QCI level KPIs included.

A fifth group of features may comprise features for SA, comprising KPIs relating, but not limited, to connected and active users, BLER, transport ratio, scheduled activity, QoS KPIs for latency, throughput and volume, Resource Block (RB) symbol utilization, SINR, MIMO ranks, RACH success rates, PDCCH and/or PDSCH utilization, PDCCH blocking ratio, scheduling efficiency, CA throughput and/or volume. The fifth group of features may also comprise overall and QCI levels KPIs-traffic volume, throughput and latency Data Radio Bearer (DRB) establish attempts, session calls, etc. The fifth group of features may further comprise features for SA, QoS and/or QCI level KPIs included.

By extracting the respective set of one or more features from each respective set of data collected from the respective set of nodes 121, 122, 123 using the respective operation mode of RAT in this Action 403, the first node 111 may then be enabled to train, or infer, a respective ML model for each respective operation mode of RAT. This may enable to build ML models that may more accurately predict or detect the behavior of the indicator of an operation of the communications system 100 in each of the different operation modes of RAT, by being tailored to each of the different operation modes of RAT.

In addition, it may be possible to predict and/or detect KPI degradation per cell usage type by clustering cells of similar geography and/or behavior, such as, for example, KPI throughput and/or latency, into K clusters. This may then be understood to enable to determine models for KPI prediction and degradation at the cluster level. KPIs at the QoS level may also be considered for degradation, to aid HO of users in case of QoS specific congestion and improvement in service specific degradations.

### Action 404

In this Action 404, the first node 111 determines, using ML, one or more ML models of an indicator of operation of the communications system 100.

The determining in this Action 402 may be understood as calculating, deriving, estimating or similar.

The indicator of operation may comprise one of: i) one or more respective first indicators of one or more KPIs, ii) one or more second indicators of handover, and iii) one or more third indicators of one or more operations based on a level of service in the communications system 100.

The one or more second indicators of handover may comprise, e.g., one or more HO thresholds, cell individual offsets, hysteresis, etc.

The one or more third indicators of the operation based on the level of service in the communications system 100 may comprise a QoS from QCI, for LTE, or 5QI, for NR. For example, latency QoS or throughput QoS, e. g, for various services such as eMBB, URLLC, mMTC etc.

The determining in this Action 404 is based on the respective operation mode of RAT used by the respective set of nodes 121, 122, 123 wherefrom the respective data has been collected to train, or infer, the respective ML model of the one or more ML models.

The one or more respective first indicators of the one or more KPIs, may comprise a KPI, such as latency, throughput, PRB utilization, uplink RSSI. In order to motivate for a multi-view framework for, for example, KPI degradation, that is, for using more than one KPI to determine cell degradation, the KPI formula and definitions may be dependent on the technology and its implementation. For example, the KPI user throughput in 5G NSA may be different for a secondary node in NR cell usage type, and for a primary node in LTE cell usage type. Also, this KPI may be defined in the Medium Access Control (MAC) layer in an NR cell and in the PDCP layer in an LTE cell.

The KPIs to be monitored may depend on the cell usage type, namely of the operation mode of RAT. For example, the NR cell usage type may consider monitoring of Uplink (UL) throughput to be of more criticality, while the LTE cell usage type may require monitoring of DL throughput.

The range of values of any KPI may be dependent on the cell usage type, that is, of the operation mode of RAT. For example, the throughput of a secondary node of a cell in NSA mode may be of the order of ~75 Mbps, as opposed to that of the primary node of the same cell in LTE mode, which may be understood to be of much lesser range, e.g., ~20 Mbps.

The KPI definition, KPIs chosen to be monitored, and the KPI degradation condition may be dependent on the cell usage type or operation mode of RAT. Accordingly, in embodiments herein, the degradation conditions may be configured for each of the K KPIs based on the operation mode of RAT. With such a multi-view framework, ML models may be designed as either proactive, to e.g., predict KPIs, or reactive, to e.g., detect KPI degradations, by considering a varied number of KPIs based on operation mode of RAT.

The ML algorithm used for the determining in this Action 404 may be any of proactive or reactive in nature, and may involve supervised/unsupervised/RL algorithms to be able to predict or detect degradations in cells.

The determining in this Action 404 of the one or more ML models may comprise a training phase, during which the one or more ML models may be trained with additionally collected data, and an inference phase.

The training during the training phase may be performed iteratively, with each pool of additionally collected data.

The inference phase may be understood as a phase wherein a respective ML model may be executed, or used, to make a particular prediction or detection. The inference phase may be reached once a desired respective accuracy level of the one or more ML models may have been reached.

By determining the one or more ML models of the indicator of operation of the communications system 100 in this Action 403, the first node 111 may be enabled to build ML models that may more accurately predict or detect the behavior of the indicator of the operation of the communications system 100 in each of the different operation modes of RAT, by being tailored to each of the different operation modes of RAT. This may in turn enable to lead to insights on the operation of the communications system 100, which may in turn enable to perform traffic management activities, such as congestion handling through alerts, problem management system, e.g., using tickets, or through automated HO actuations. For example, proactive traffic balancing methods may comprise predicting KPI degradation at a cell level using KPIs indicative of cell spectrum utilization, coverage, and accessibility features in advance of H hours. Such predictions may in turn be used to initiate handover actuations so that the devices may be enabled to be served by a neighboring cell with available resources. A holistic viewpoint of degradation may be enabled by considering multiple KPI in the proactive, or reactive, ML models.

The 5G NSA, SA and DSS implementations may bring in challenges and offerings in terms of network utilization and capabilities. Embodiments herein may enable to analyze 5QI and/or QoS KPI degradation in NSA, SA and/or LTE for a finer viewpoint of service level performance and better user experience.

### Action 405

In this Action 405, the first node 111 provides a respective indication of the determined one or more ML models to the second node 112 operating in the communications system 100.

The respective indication may for example, comprise the trained one more ML models, so that the second node 112 may be enabled to use the one or more ML models to make predictions and/or detections. In other examples, the respective indication may comprise a prediction and/or detection performed by using the one or more ML models, on e.g., new sets of data.

In some examples, the second node 112 may be a different node than the first node 111. In such examples, providing in this Action 405 may comprise sending or transmitting the respective indication, e.g., via the first link 151.

In other examples, the second node 112 may be the same node as the first node 111. In such examples, the providing in this Action 405 may comprise outputting the respective indication.

By providing the respective indication to the second node 112 in this Action 405, the first node 111 may enable the second node 112 to then use the ML models to more accurately predict or detect the behavior of the indicator of the operation of the communications system 100 in each of the different operation modes of RAT, by being tailored to each of the different operation modes of RAT. This may in turn enable to lead to insights on the operation of the communications system 100, which may in turn enable the second node 112 to perform traffic management activities such as congestion handling through alerts, problem management system, e.g., using tickets, or through automated HO actuations.

### Action 406

As stated earlier, the insights from ML based degradation predictions of the indicator of operation, e.g., 5G KPI degradation predictions, may aid to perform traffic management activities such as congestion handling through alerts, problem management system, e.g., using tickets, or through automated HO actuations.

In this Action 406, the first node 111 may perform one or more actions based on the respective indication of the determined one or more ML models. The one or more actions may be interventions. The one or more actions may comprise at least one of: balancing of traffic in the communications system 100, and management of the indicator of performance of the communications system 100.

The performance of the actions may comprise sending an instruction to another node to e.g., perform a change in a configuration, or to handover users from one cell to another.

The balancing of traffic may comprise, e.g., automatic or manual HO actuation by moving devices to another cell through changing HO thresholds.

The management of the indicator of performance may comprise hand over to a problem management function through a ticket or raising one or more alerts/alarms.

In some embodiments, the one or more actions may comprise at least one actuation.

In some embodiments, the at least one actuation may comprise an HO actuation. One of the approaches in effectively managing traffic may be through HO actuations. Handovers may involve moving a device from one congested cell to another. HO actuations may result from either a manual trigger effected by a network operator, or automated triggers from proactive and/or reactive ML based model outcomes, such as cells in which one or more KPIs may be degraded. In embodiments herein, the first node 111 may effect HO actuations through HO thresholds, cell individual offsets and/or hysteresis.

In a 5G network, for example, the possible combinations in handovers may include 4G-5G, 5G-5G and/or 5G-4G. Some of the challenges that may arise from automated triggers may pertain to the ping-pong effect, and may need for change reversion if the target cells themselves get congested. This HO triggers that may enable load balancing may need to be timed and at the same time meet/satisfy certain criteria in order to avoid unnecessary actuations. According to examples of embodiments herein, the following aspects may be included in the trigger mechanisms for mitigating ping-pong effects. A first aspect may be that multiple KPI based ML models may give varied view-points, reducing the number of spurious requests for HO. For example, KPI1, e.g., Throughput, and KPI2, e.g., latency, may both be required to be degraded at the same time for the HO to be actuated. A second aspect may be to monitor traffic-volume, for example, ENDC traffic-volume in DSS scenarios, as well to decide handovers. As a further particular example, ENDC traffic volume exceeding a threshold may trigger HO actuations. The thresholds may be decided based on network usage conditions and deployment context. A third aspect may be sustained degradation in both modelling and actuation by monitoring for longer periods before initiating an HO. For example, KPIs being degraded for last or previous historic N Reporting output periods (ROPs) may trigger HO actuations. A fourth aspect may be a 5QI/QoS based KPI degradation viewpoint for better granular detail in terms of services affected by the degradation. The outcomes from ML models for 5QI/QoS KPI degradations may be consolidated with the outcomes from ML models of corresponding overall KPI degradations. Rules may be decided by network operators. These rules may also be learnt using ML models if the cell degradations may be tagged. This in turn may also be used to actuate HO of users of specific services which may be degrading as per the ML model outcome.

In the case of 5G, for example, embodiments herein may enable to address the challenges in network traffic management through proactive, or reactive, traffic balancing, based on KPI degradation conditions. In order to effectively utilize 5QI/QoS architecture for service level enhancements, 5QI level KPI(s) to be indicative of cell degradation, and which may negatively impact user experience may be predicted and/or detected. Such users may then be handed over from one cell to another for the same service. The same may be extended to 4G for QoS KPIs. A unique logic may be applied to aggregate the QoS KPI degradations and ensure sustained degradation before actuating HO.

By performing the one or more actions in this Action 403, the first node 111 may then be enabled to balance the traffic in the communications system 100, and manage the indicator of performance of the communications system 100 so that the performance of the communications system 100 may be improved.

Embodiments of a computer-implemented method, performed by the second node 112, will now be described with reference to the flowchart depicted in FIG. 5. The method is for handling the one or more ML models. The second node 112 operates in the communications system 100.

In some embodiments, the communications system 100 may comprise one of: i) a 5G architecture, and ii) a 4G architecture.

Several embodiments are comprised herein. In some embodiments all the actions may be performed. In some embodiments, some actions may be optional. In FIG. 5, optional actions are indicated with dashed lines. It should be noted that the examples herein are not mutually exclusive. Components from one embodiment may be tacitly assumed to be present in another embodiment and it will be obvious to a person skilled in the art how those components may be used in the other exemplary embodiments. One or more embodiments may be combined, where applicable. All possible combinations are not described to simplify the description. For example, in some embodiments, the actuations may comprise an HO actuation.

### Action 501

In this Action 501, the second node 112 receives, from the first node 111 operating in the communications system 100, the respective indication of the one or more ML models of the indicator of operation of the communications system 100.

The one or more ML models are based on the respective operation mode of RAT, used by the respective set of nodes 121, 122, 123 wherefrom the respective data have been collected to train, or infer, the respective ML model of the one or more ML models.

The indicator of operation may comprise one of: i) the one or more respective first indicators of the one or more KPIs, ii) the one or more second indicators of handover, and iii) the one or more third indicators of the one or more operations based on the level of service in the communications system 100.

The receiving may be performed, e.g., via the first link 151.

The data may comprise at least one of: i) the first data comprising information about the respective site where the data was collected, ii) the second data indicating PM data, iii) the third data indicting fault management data, iv) the fourth data indicating configuration management data, v) the fifth data indicating call trace records, and vi) the sixth data comprising historical data.

In some embodiments, the respective operation mode of RAT may comprise at least one of: i) SA operation with one RAT, ii) Non-SA with the first RAT, ili) Non-SA with the second RAT, iv) spectrum sharing, e.g., DSS, between the first RAT and the second RAT, and v) CA. The ML based embodiments may also be extended for LTE as the embodiments may be understood to address 5G-NSA architecture as well.

In some embodiments, the respective operation mode of RAT may comprise at least one of: (i) SA operation with one RAT, where in the one RAT is NR, e.g., excluding DSS, (ii) SA operation with DSS, wherein spectrum is shared between NR UEs and pure LTE or ENDC-LTE or ENDC-NR UEs, and (iii) SA operation with CA.

Each respective ML model may comprise the respective set of one or more features.

By receiving the respective indication from the first node 111 in this Action 501, the second node 112 may be enabled to then use the one or more ML models to more accurately predict or detect the behavior of the indicator of the operation of the communications system 100 in each of the different operation modes of RAT, by being tailored to each of the different operation modes of RAT. This may in turn enable to lead to insights on the operation of the communications system 100, which may in turn enable the second node 112 to perform traffic management activities, such as congestion handling through alerts, problem management system, e.g., using tickets, or through automated HO actuations.

### Action 502

In some embodiments, the respective data may be first respective data, that is, a first set of data, and the respective set of nodes 121, 122, 123 may be a first respective set of nodes 121, 122, 123. In some of these embodiments, in this Action 502, the second node 112 may obtain second respective data from a respective second set of nodes 131, 132. The data may be collected from the plurality of second sets of nodes 130. That is, in this Action 502, the second node 112 may receive a new set of data, which the second node 112 may use to run the one or more ML models to make predictions and/or detections of the indicator of operation of the communications system 100.

### Action 503

In some of the embodiments wherein the respective data may be the first respective data, that is, the first set of data, and the respective set of nodes 121, 122, 123 may be the first respective set of nodes 121, 122, 123, in this Action 503, the second node 112 may determine the respective operation mode of RAT of each respective second set of nodes 131, 132 in the plurality of second sets of nodes 130, such that a second respective set of data may be selected for inferencing a respective ML model for the respective operation mode of RAT.

In some embodiments, a same node 134 in the plurality of second sets of nodes 130 may operate with different operation modes of RAT at different respective periods of time and may yield respective second subsets of data for each respective operation mode of RAT of the different operations modes of RAT. In some of such embodiments, the determining in this Action 503 of the respective operation mode of RAT of each second respective set of nodes 131, 132 may be performed for a respective period of time.

### Action 504

In this Action 504, the second node 112 may infer the one or more ML models indicated by the received respective indication, using the second respective set of data, and based on the determined respective operation mode of RAT, to make a respective prediction or detection of the indicator in the determined respective operation mode of RAT.

### Action 505

In this Action 505, the second node 112 performs one or more actions based on the received respective indication of the one or more ML models.

In some embodiments, the performing in this Action 505 of the one or more actions may be based on the respective prediction or detection.

In some embodiments, at least one of the following may apply. According to a first option, the one or more actions may be interventions. According to a second option, the one or more actions may comprise at least one of: i) balancing of traffic in the communications system 100, and ii) management of the indicator of performance of the communications system 100. According to a third option, the one or more actions may comprise at least one actuation.

By performing the one or more actions in this Action 505, the second node 112 may then be enabled to balance the traffic in the communications system 100, and manage the indicator of performance of the communications system 100 so that the performance of the communications system 100 may be improved.

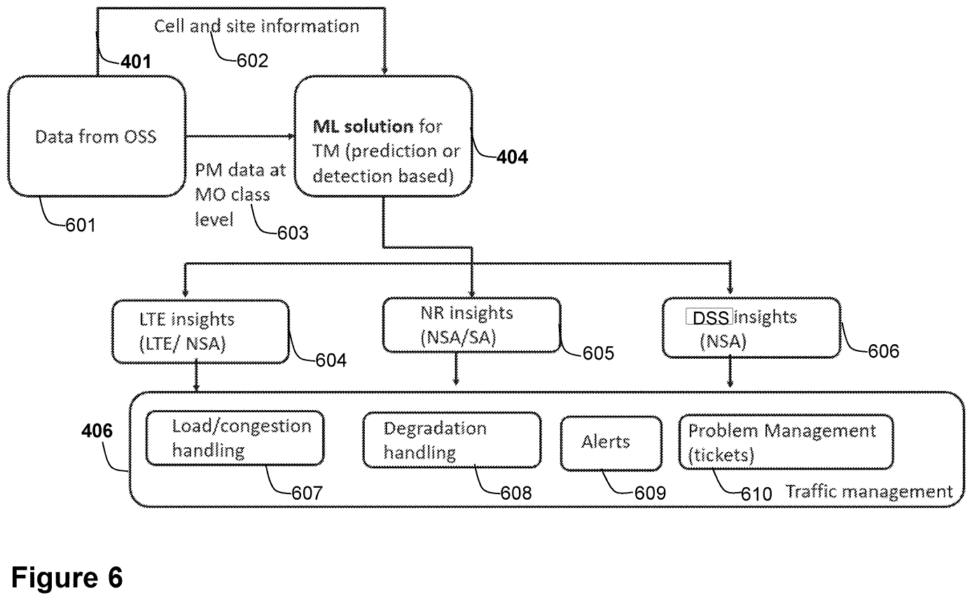

FIG. 6 is a schematic diagram depicting a non-limiting example of the method performed by the first node 111, according to embodiments herein. In this example, the method is performed for network traffic management for 5G technology. The block diagram of is depicted with end-to-end flow of data from the OSS at 601, being obtained by the first node 111 in accordance with Action 401. The respective data from the respective set of nodes 121, 122, 123 may comprise first data 602 comprising information about the respective site where the data was collected, and second data 603 indicating PM data at the Managed Object (MO) class level. The obtained respective data may be used to determine, according to Action 404, the one or more ML models for traffic management (TM) prediction or detection. Once trained, the one or more ML models may yield insights, such as LTE insights 604, e.g., LTE and/or NSA, NR insights 605, e.g., NSA and/or SA and DSS insights 606, e.g., NSA. These insights may then be used to perform the one or more actions in traffic management, in accordance with Action 406. The one or more actions may comprise load and/or congestion handling 607, degradation handling 608, alerts 609 and problem management 610, e.g., tickets.

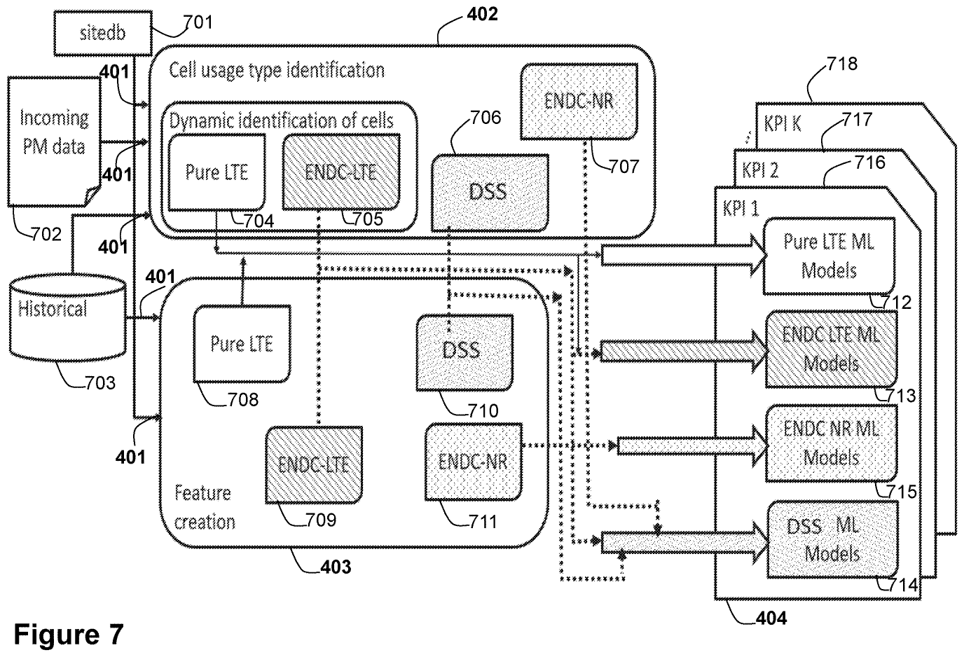

FIG. 7 is a schematic illustration depicting another non-limiting example of the method performed by the first node 111, according to embodiments herein. In this example, the method is performed for 5G (NSA) traffic management. The respective data from the respective set of nodes 121, 122, 123 may comprise the first data 701 comprising information about the respective site where the data was collected, the second data 702 indicating the incoming PM data and the sixth data 703 comprising historical data. The respective data may be obtained according to Action 401, and used in Action 402 to determine the respective operation mode of RAT of each respective set of nodes 121, 122, 123 in the plurality of sets of nodes 120, that is, to perform the identification of the cell usage type. According to Action 402, a dynamic identification of cells may be performed to identify cells as pure LTE and ENDC-LTE, DSS and ENDC-NR. This may be understood to yield four different respective sets of data which may be selected for training, or inferencing, a respective ML model for a respective operation mode of RAT. A first respective set of data 704 may be selected for the pure LTE operation mode of RAT. A second respective set of data 705 may be selected for the ENDC LTE operation mode of RAT. A third respective set of data 706 may be selected for the DSS operation mode of RAT. A fourth respective set of data 707 may be selected for the pure ENDC-NR operation mode of RAT. In Action 403, the first node 111 may then extract, or create, the respective set of one or more features from each respective set of data in order to train, or infer, the respective ML model. A first respective set of one or more features 708 may be extracted from the respective set of data for the pure LTE operation mode of RAT. A second respective set of one or more features 709 may be extracted from the respective set of data for the pure ENDC-LTE operation mode of RAT. A third respective set of one or more features 710 may be extracted from the respective set of data for the DSS operation mode of RAT. A fourth respective set of one or more features 711 may be extracted from the respective set of data for the ENDC-NR operation mode of RAT. The four different respective sets of data may then be used for training, or inferencing, a respective ML model for a respective operation mode of RAT, according to Action 404. The first respective set of one or more features 708 may be used to train a first respective set of pure LTE ML models 712. The second respective set of one or more features 709 may be used to train a first respective set of ENDC-LTE ML models 713. The third respective set of one or more features 710 may be used to train a first respective set of DSS ML models 714. The fourth respective set of one or more features 711 may be used to train a first respective set of ENDC-NR ML models 715. The same process may be repeated for each indicator of operation of the communications system 100 that may be wished to be predicted and/or detected, such as a KPI 1 716, KPI 2 717 and KPI 3 718.

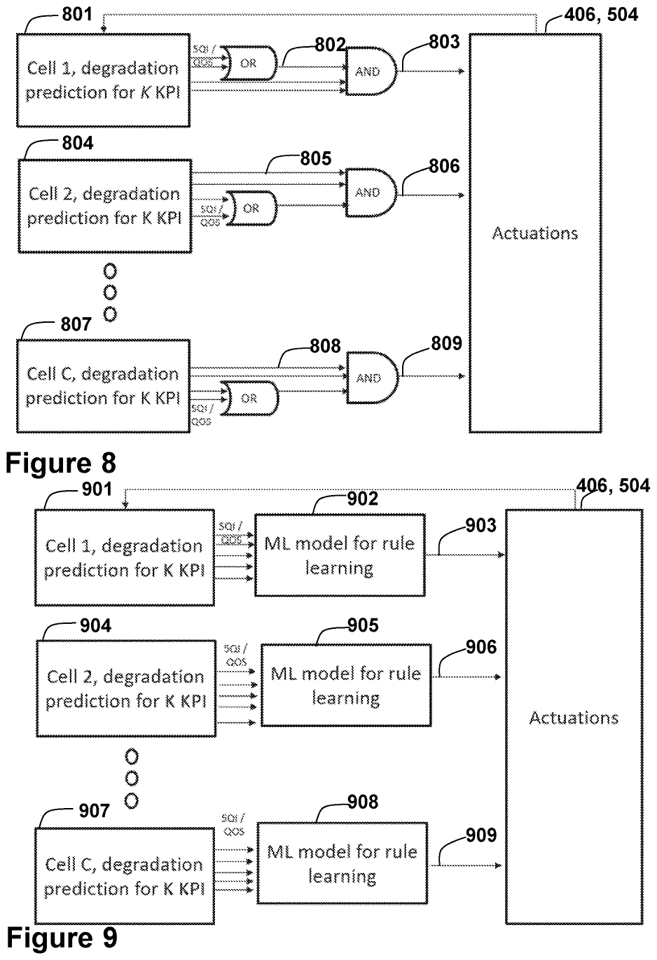

The outcomes from ML models for 5QI and/or QoS KPI degradations may be consolidated with the outcomes from ML models of corresponding overall KPI degradations as shown in FIG. 8 and FIG. 9 to use 5QI/QoS viewpoints in HO actuations, as performed by the first node 111, according to Action 406, and/or the second node 112, according to Action 505. FIG. 8 is a schematic diagram depicting rules as decided by network operators. In a first cell, cell 1, a degradation for K KPI 801 may lead to a respective first set of operator rules 802, expressed with “AND” “OR” terms, to perform a respective first set of actuations 803. In a second cell, cell 2, a degradation for K KPI 804 may lead to a respective second set of operator rules 805 to perform a respective second set of actuations 806. In a third cell, cell 3, a degradation for K KPI 807 may lead to a respective third set of operator rules 808 to perform a respective third set of actuations 809, and so and so forth.

These rules may also be learnt using ML models if the cell degradations may be tagged, as shown in the schematic diagram of FIG. 9. This in turn may also be used to actuate HO of users of specific services which may be degrading as per the ML model outcome. HO triggers may be made configurable using KPI ML model outputs and insights for various other such combinations. In a first cell, cell 1, a degradation for K KPI 901 may lead to a respective first ML model for rule learning 902, to perform a respective first set of actuations 903. In a second cell, cell 2, a degradation for K KPI 904 may lead to a respective second ML model for rule learning 905 to perform a respective second set of actuations 906. In a third cell, cell 3, a degradation for K KPI 807 may lead to a respective third ML model for rule learning 908 to perform a respective third set of actuations 909, by the first node 1111, according to Action 406, and/or by the second node 112, according to Action 505.

Embodiments herein may be understood to be generic because of the following aspects. A first aspect may be that the above proposed components may constitute pre-processing and post-processing procedures of an ML approach in 5G. Hence, embodiments herein may be applied to any ML-based approach to manage traffic in a network and may not need to be restricted to either a reactive or a proactive ML approach. The 5G KPI degradation prediction may lead to traffic management activities. A second aspect may be that the ML approach may be used for LTE also because particular embodiments herein have been designed for 5G-NSA implementation. A third aspect may be understood to be that the 5QI architecture may be extended to 4G for QoS KPIs.

Certain embodiments herein may provide one or more of the following technical advantage(s). A first technical advantage may be understood to be that 5G implementation may be considered and deployable solutions. As a second technical advantage, embodiments herein may be understood to be scalable with 5G NSA and/or SA, network size, geography, and/or DSS implementations. As a third technical advantage, embodiments herein may be understood to provide approaches tailored for NSA and SA architectures. As a fourth technical advantage, embodiments herein may be understood to consider 5QI (QoS) architecture. As a fifth technical advantage, embodiments herein may be understood to be extendable to any ML approach and not limited to traffic balancing.

Embodiments herein may comprise any ML approaches for network management in a complex technology, such as 5G in combination with 4G, and in different modes such as NSA/SA and DSS. Embodiments herein may dynamically identify the performance indicators, degradation condition and lead to automated, decision support enabling actions. Embodiments herein may also address the service level enhancements that may be utilized due to the 5G architecture. The approach may be understood to hold for any other ML approach which may be formulated from any of the five data sources, and may not be limited to network traffic management.

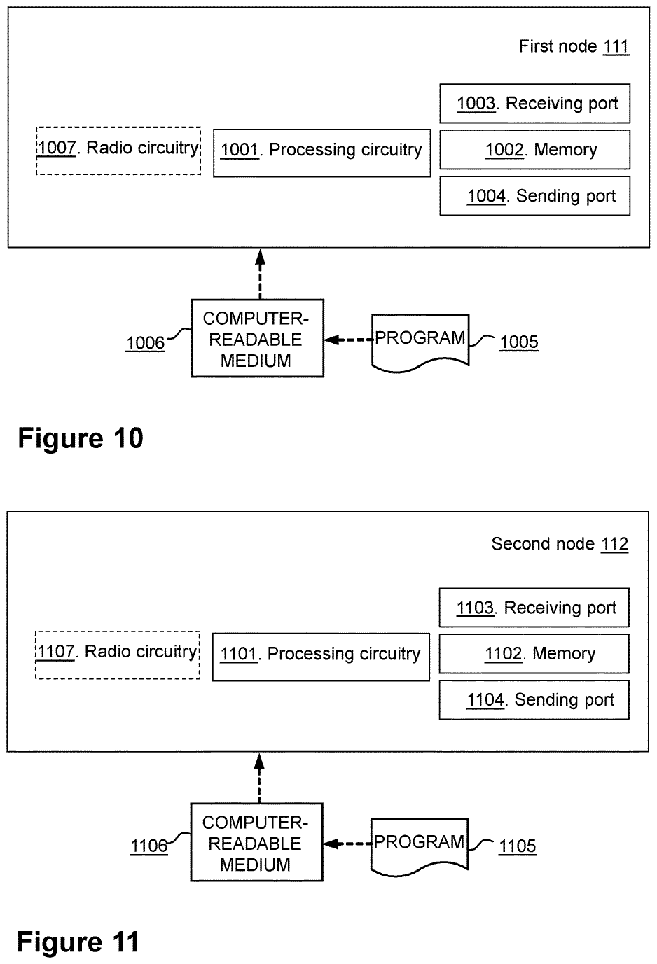

FIG. 10 depicts an example of the arrangement that the first node 111 may comprise to perform the method described in in FIG. 4 and/or FIGS. 6-9. The first node 111 may be understood to be for handling the one or more ML models. The first node 111 is configured to operate in the communications system 100.

Several embodiments are comprised herein. It should be noted that the examples herein are not mutually exclusive. One or more embodiments may be combined, where applicable. All possible combinations are not described to simplify the description. Components from one embodiment may be tacitly assumed to be present in another embodiment and it will be obvious to a person skilled in the art how those components may be used in the other exemplary embodiments. The detailed description of some of the following corresponds to the same references provided above, in relation to the actions described for the first node 111, and will thus not be repeated here. For example, in some embodiments, the actuations may be configured to comprise an HO actuation.

The first node 111 is configured to determine, using ML, the one or more ML models of the indicator of operation of the communications system 100. The determining is configured to be based on the respective operation mode of RAT configured to be used by the respective set of nodes 121, 122, 123 wherefrom the respective data is configured to have been collected to train, or infer, the respective ML model of the one or more ML models.

The first node 111 is also configured to provide the respective indication of the one or more ML models configured to be determined to the second node 112 configured to operate in the communications system 100.

In some embodiments, the first node 111 may be further configured to obtain the respective data from the respective set of nodes 121, 122, 123. The data may be configured to be collected from the plurality of sets of nodes 120.

In some embodiments, the first node 111 may be further configured to determine the respective operation mode of RAT of each respective set of nodes 121, 122, 123 in the plurality of sets of nodes 120, such that the respective set of data may be configured to be selected for training, and/or inferencing from, the respective ML model for the respective operation mode of RAT.

In some embodiments, the same node 124 in the plurality of sets of nodes 120 may be configured to operate with different operation modes of RAT at different respective periods of time. In some of such embodiments, the first node 111 may be configured to yield the respective subsets of data for each respective operation mode of RAT of the different operations modes of RAT. In such embodiments, the determining of the respective operation mode of RAT of each respective set of nodes 121, 122, 123 may be configured to be performed for the respective period of time.

In some embodiments, wherein the respective set of data may be configured to be selected for training, or inferencing, the respective ML model for the respective operation mode of RAT, and wherein the respective set of data may be configured to have been collected from the respective set of nodes 121, 122, 123 configured to be using the respective operation mode of RAT, the first node 111 may be further configured to extract, out of the data configured to be collected, the respective set of one or more features from each respective set of data in order to train, or infer, the respective ML model.

In some embodiments, the determining of the one or more ML models may be configured to comprise the training phase, during which the one or more ML models may be configured to be trained with additionally collected data, and the inference phase, wherein the inference phase may be configured to be reached once the desired respective accuracy level of the one or more ML models may be reached.

In some embodiments, the first node 111 may be further configured to perform the one or more actions based on the respective indication of the one or more ML models configured to be determined. The one or more actions may be configured to be interventions, and the one or more actions may be configured to comprise at least one of: i) the balancing of traffic in the communications system 100, and ii) the management of the indicator of performance of the communications system 100.

In some embodiments, the one or more actions may be configured to comprise at least one actuation.

In some embodiments, at least one of the following options may apply. According to a first option, the indicator of operation may be configured to comprise one of: i) the one or more respective first indicators of the one or more KPIs, ii) the one or more second indicators of handover, and iii) the one or more third indicators of the one or more operations based on the level of service in the communications system 100. According to a second option, the data may be configured to comprise at least one of: i) the first data configured to comprise the information about the respective site where the data was collected, ii) the second data configured to indicate the performance management data, iii) the third data configured to indicate the fault management data, iv) the fourth data configured to indicate the configuration management data, v) the fifth data configured to indicate the call trace records, and vi) the sixth data configured to comprise the historical data. According to a third option, the respective operation mode of RAT may be configured to comprise at least one of: i) the SA operation with one RAT, ii) the Non-SA with the first RAT, iii) the Non-SA with the second RAT, iv) Spectrum sharing between the first RAT and the second RAT, and v) Carrier aggregation.

According to a fourth option, the respective operation mode of RAT may be configured to comprise at least one of: (i) SA operation with one RAT, wherein the one RAT is configured to be NR, e.g., excluding DSS, (ii) SA operation with DSS, wherein spectrum is configured to be shared between NR UEs and pure LTE or ENDC-LTE or ENDC-NR UEs, and (iii) SA operation with CA. According to a fifth option, the communications system 100 may be configured to comprise one of: i)the 5G architecture, and ii) the 4G architecture.

The embodiments herein in the first node 111 may be implemented through one or more processors, such as a processing circuitry 1001 in the first node 111 depicted in FIG. 10, together with computer program code for performing the functions and actions of the embodiments herein. A processor, as used herein, may be understood to be a hardware component. The program code mentioned above may also be provided as a computer program product, for instance in the form of a data carrier carrying computer program code for performing the embodiments herein when being loaded into the first node 111. One such carrier may be in the form of a CD ROM disc. It is however feasible with other data carriers such as a memory stick. The computer program code may furthermore be provided as pure program code on a server and downloaded to the first node 111.

The first node 111 may further comprise a memory 1002 comprising one or more memory units. The memory 1002 is arranged to be used to store obtained information, store data, configurations, schedulings, and applications etc. to perform the methods herein when being executed in the first node 111.

In some embodiments, the first node 111 may receive information from, e.g., the second node 112, any of the nodes in plurality of sets of nodes 120, any of the nodes in the plurality of second sets of nodes 130, any of the first device 141, the second device 142, the third device 143, the fourth device 144, and the fifth device 145, and/or another structure in the wireless communications network 100, through a receiving port 1003. In some embodiments, the receiving port 1003 may be, for example, connected to one or more antennas in first node 111. In other embodiments, the first node 111 may receive information from another structure in the wireless communications network 100 through the receiving port 1003. Since the receiving port 1003 may be in communication with the processing circuitry 1001, the receiving port 1003 may then send the received information to the processing circuitry 1001. The receiving port 1003 may also be configured to receive other information.

The processing circuitry 1001 in the first node 111 may be further configured to transmit or send information to e.g., the second node 112, any of the nodes in plurality of sets of nodes 120, any of the nodes in the plurality of second sets of nodes 130, any of the first device 141, the second device 142, the third device 143, the fourth device 144, and the fifth device 145, and/or another structure in the wireless communications network 100, through a sending port 1004, which may be in communication with the processing circuitry 1001, and the memory 1002.

Those skilled in the art will also appreciate that the units comprised within the first node 111 described above as being configured to perform different actions, may refer to a combination of analog and digital circuits, and/or one or more processors configured with software and/or firmware, e.g., stored in memory, that, when executed by the one or more processors such as the processing circuitry 1001, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Also, in some embodiments, the different units comprised within the first node 111 described above as being configured to perform different actions described above may be implemented as one or more applications running on one or more processors such as the processing circuitry 1001.

Thus, the methods according to the embodiments described herein for the first node 111 may be respectively implemented by means of a computer program 1005 product, comprising instructions, i.e., software code portions, which, when executed on at least one processing circuitry 1001, cause the at least one processing circuitry 1001 to carry out the actions described herein, as performed by the first node 111. The computer program 1005 product may be stored on a computer-readable storage medium 1006. The computer-readable storage medium 1006, having stored thereon the computer program 1005, may comprise instructions which, when executed on at least one processing circuitry 1001, cause the at least one processing circuitry 1001 to carry out the actions described herein, as performed by the first node 111. In some embodiments, the computer-readable storage medium 1006 may be a non-transitory computer-readable storage medium, such as a CD ROM disc, or a memory stick. In other embodiments, the computer program 1005 product may be stored on a carrier containing the computer program 1005 just described, wherein the carrier is one of an electronic signal, optical signal, radio signal, or the computer-readable storage medium 1006, as described above.

The first node 111 may comprise a communication interface configured to facilitate, or an interface unit to facilitate, communications between the first node 111 and other nodes or devices, e.g., the second node 112, any of the nodes in plurality of sets of nodes 120, any of the nodes in the plurality of second sets of nodes 130, any of the first device 141, the second device 142, the third device 143, the fourth device 144, and the fifth device 145, and/or another structure in the wireless communications network 100. The interface may, for example, include a transceiver configured to transmit and receive radio signals over an air interface in accordance with a suitable standard.

In other embodiments, the first node 111 may comprise a radio circuitry 1007, which may comprise e.g., the receiving port 1003 and the sending port 1004.

The radio circuitry 1007 may be configured to set up and maintain at least a wireless connection with the second node 112, any of the nodes in plurality of sets of nodes 120, any of the nodes in the plurality of second sets of nodes 130, any of the first device 141, the second device 142, the third device 143, the fourth device 144, and the fifth device 145, and/or another structure in the wireless communications network 100. Circuitry may be understood herein as a hardware component.

Hence, embodiments herein also relate to the first node 111 operative to operate in the wireless communications network 100. The first node 111 may comprise the processing circuitry 1001 and the memory 1002, said memory 1002 containing instructions executable by said processing circuitry 1001, whereby the first node 111 is further operative to perform the actions described herein in relation to the first node 111, e.g., in FIG. 4 and/or FIGS. 6-9.

FIG. 11 depicts an example of the arrangement that the second node 112 may comprise to perform the method described in FIG. 5 and/or FIGS. 8-9. The second node 112 may be understood to be for handling the one or more ML models. The second node 112 is configured to operate in the communications system 100.

Several embodiments are comprised herein. It should be noted that the examples herein are not mutually exclusive. One or more embodiments may be combined, where applicable. All possible combinations are not described to simplify the description. Components from one embodiment may be tacitly assumed to be present in another embodiment and it will be obvious to a person skilled in the art how those components may be used in the other exemplary embodiments. The detailed description of some of the following corresponds to the same references provided above, in relation to the actions described for the second node 112, and will thus not be repeated here. For example, in some embodiments, the actuations may be configured to comprise an HO actuation.

The second node 112 is configured to receive, from the first node 111 configured to operate in the communications system 100, the respective indication. The respective indication is of the one or more ML models of the indicator of operation of the communications system 100. The one or more ML models are configured to be based on the respective operation mode of RAT configured to be used by the respective set of nodes 121, 122, 123 wherefrom the respective data is configured to have been collected to train, or infer, the respective ML model of the the one or more ML models.

The second node 112 is also configured to perform the one or more actions based on the respective indication of the one or more ML models configured to be received.

In some embodiments, wherein the respective set of data may be configured to be selected for training, or inferencing, the respective ML model for the respective operation mode of RAT, and wherein the respective set of data may be configured to have been collected from the respective set of nodes 121, 122, 123 configured to be using the respective operation mode of RAT, the first node 111 may be further configured to extract, out of the data configured to be collected, the respective set of one or more features from each respective set of data in order to train, or infer, the respective ML model.

In some embodiments wherein the respective data may be configured to be the first respective data, and the respective set of nodes 121, 122, 123 may be configured to be the first respective set of nodes 121, 122, 123, the second node 112 may be further configured to obtain the second respective data from the respective second set of nodes 131, 132, wherein the data may be configured to be collected from the plurality of second sets of nodes 130.

In some embodiments wherein the respective data may be configured to be the first respective data, and the respective set of nodes 121, 122, 123 may be configured to be the first respective set of nodes 121, 122, 123, the second node 112 may be further configured to determine the respective operation mode of RAT of each respective second set of nodes 131, 132 in the plurality of second sets of nodes 130, such that the second respective set of data may be selected for inferencing the respective ML model for the respective operation mode of RAT.

In some embodiments wherein the respective data may be configured to be the first respective data, and the respective set of nodes 121, 122, 123 may be configured to be the first respective set of nodes 121, 122, 123, the second node 112 may be further configured to infer the one or more ML models configured to be indicated by the respective indication configured to be received, using the second respective set of data, and based on the respective operation mode of RAT configured to be determined, to make the respective prediction or detection of the indicator in the respective operation mode of RAT configured to be determined. In some of such embodiments, the performing of the one or more actions may be configured to be based on the respective prediction or detection.

In some embodiments, at least one of the following options may apply. According to a first option, the one or more actions may be configured to be interventions. According to a second option, the one or more actions may be configured to comprise at least one of: i) the balancing of traffic in the communications system 100, and ii) the management of the indicator of performance of the communications system 100. According to a third option, the one or more actions may be configured to comprise at least one actuation.

In some embodiments, wherein the same node 134 in the plurality of second sets of nodes 130 may be configured to operate with different operation modes of RAT at different respective periods of time and may yield respective second subsets of data for each respective operation mode of RAT of the different operations modes of RAT, the determining of the respective operation mode of RAT of each respective second set of nodes 131, 132 may be configured to be performed for a respective period of time.

In some embodiments, each respective ML model may be configured to comprise the respective set of one or more features.

In some embodiments, at least one of the following options may apply. According to the first option, the indicator of operation may be configured to comprise one of: i) the one or more respective first indicators of the one or more KPIs, ii) the one or more second indicators of handover, and iii) the one or more third indicators of the one or more operations based on the level of service in the communications system 100. According to the second option, the data may be configured to comprise at least one of: i) the first data configured to comprise the information about the respective site where the data was collected, ii) the second data configured to indicate the performance management data, ili) the third data configured to indicate the fault management data, iv) the fourth data configured to indicate the configuration management data, v) the fifth data configured to indicate the call trace records, and vi) the sixth data configured to comprise the historical data. According to the third option, the respective operation mode of RAT may be configured to comprise at least one of: i) the SA operation with one RAT, ii) the Non-SA with the first RAT, iii) the Non-SA with the second RAT, iv) Spectrum sharing between the first RAT and the second RAT, and v) Carrier aggregation. According to the fourth option, the respective operation mode of RAT may be configured to comprise at least one of: i) SA operation with one RAT, wherein the one RAT is configured to be NR, e.g., excluding DSS, (ii) SA operation with DSS, wherein spectrum is configured to be shared between NR UEs and pure LTE or ENDC-LTE or ENDC-NR UEs, and (ili) SA operation with CA. According to the fifth option, the communications system 100 may be configured to comprise one of: i) the 5G architecture, and ii) the 4G architecture.

The embodiments herein in the second node 112 may be implemented through one or more processors, such as a processing circuitry 1101 in the second node 112 depicted in FIG. 11, together with computer program code for performing the functions and actions of the embodiments herein. A processor, as used herein, may be understood to be a hardware component. The program code mentioned above may also be provided as a computer program product, for instance in the form of a data carrier carrying computer program code for performing the embodiments herein when being loaded into the second node 112. One such carrier may be in the form of a CD ROM disc. It is however feasible with other data carriers such as a memory stick. The computer program code may furthermore be provided as pure program code on a server and downloaded to the second node 112.

The second node 112 may further comprise a memory 1102 comprising one or more memory units. The memory 1102 is arranged to be used to store obtained information, store data, configurations, schedulings, and applications etc. to perform the methods herein when being executed in the second node 112.

In some embodiments, the second node 112 may receive information from, e.g., the first node 111, any of the nodes in plurality of sets of nodes 120, any of the nodes in the plurality of second sets of nodes 130, any of the first device 141, the second device 142, the third device 143, the fourth device 144, and the fifth device 145, and/or another structure in the wireless communications network 100, through a receiving port 1103. In some embodiments, the receiving port 1103 may be, for example, connected to one or more antennas in second node 112. In other embodiments, the second node 112 may receive information from another structure in the wireless communications network 100 through the receiving port 1103. Since the receiving port 1103 may be in communication with the processing circuitry 1101, the receiving port 1103 may then send the received information to the processing circuitry 1101. The receiving port 1103 may also be configured to receive other information.

The processing circuitry 1101 in the second node 112 may be further configured to transmit or send information to e.g., the first node 111, any of the nodes in plurality of sets of nodes 120, any of the nodes in the plurality of second sets of nodes 130, any of the first device 141, the second device 142, the third device 143, the fourth device 144, and the fifth device 145, and/or another structure in the wireless communications network 100, through a sending port 1104, which may be in communication with the processing circuitry 1101, and the memory 1102.

Those skilled in the art will also appreciate that the units comprised within the second node 112 described above as being configured to perform different actions, may refer to a combination of analog and digital circuits, and/or one or more processors configured with software and/or firmware, e.g., stored in memory, that, when executed by the one or more processors such as the processing circuitry 1101, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Also, in some embodiments, the different units comprised within the second node 112 described above as being configured to perform different actions described above may be implemented as one or more applications running on one or more processors such as the processing circuitry 1101.

Thus, the methods according to the embodiments described herein for the second node 112 may be respectively implemented by means of a computer program 1105 product, comprising instructions, i.e., software code portions, which, when executed on at least one processing circuitry 1101, cause the at least one processing circuitry 1101 to carry out the actions described herein, as performed by the second node 112. The computer program 1105 product may be stored on a computer-readable storage medium 1106. The computer-readable storage medium 1106, having stored thereon the computer program 1105, may comprise instructions which, when executed on at least one processing circuitry 1101, cause the at least one processing circuitry 1101 to carry out the actions described herein, as performed by the second node 112. In some embodiments, the computer-readable storage medium 1106 may be a non-transitory computer-readable storage medium, such as a CD ROM disc, or a memory stick. In other embodiments, the computer program 1105 product may be stored on a carrier containing the computer program 1105 just described, wherein the carrier is one of an electronic signal, optical signal, radio signal, or the computer-readable storage medium 1106, as described above.

The second node 112 may comprise a communication interface configured to facilitate, or an interface unit to facilitate, communications between the second node 112 and other nodes or devices, e.g., the first node 111, any of the nodes in plurality of sets of nodes 120, any of the nodes in the plurality of second sets of nodes 130, any of the first device 141, the second device 142, the third device 143, the fourth device 144, and the fifth device 145, and/or another structure in the wireless communications network 100. The interface may, for example, include a transceiver configured to transmit and receive radio signals over an air interface in accordance with a suitable standard.

In other embodiments, the second node 112 may comprise a radio circuitry 1107, which may comprise e.g., the receiving port 1103 and the sending port 1104.

The radio circuitry 1107 may be configured to set up and maintain at least a wireless connection with the first node 111, any of the nodes in plurality of sets of nodes 120, any of the nodes in the plurality of second sets of nodes 130, any of the first device 141, the second device 142, the third device 143, the fourth device 144, and the fifth device 145, and/or another structure in the wireless communications network 100. Circuitry may be understood herein as a hardware component.

Hence, embodiments herein also relate to the second node 112 operative to operate in the wireless communications network 100. The second node 112 may comprise the processing circuitry 1101 and the memory 1102, said memory 1102 containing instructions executable by said processing circuitry 1101, whereby the second node 112 is further operative to perform the actions described herein in relation to the second node 112, e.g., in FIG. 5 and/or FIGS. 8-9.

When using the word “comprise” or “comprising”, it shall be interpreted as non-limiting, i.e., meaning “consist at least of”.

The embodiments herein are not limited to the above-described preferred embodiments. Various alternatives, modifications and equivalents may be used. Therefore, the above embodiments should not be taken as limiting the scope of the invention.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

As used herein, the expression “at least one of:” followed by a list of alternatives separated by commas, and wherein the last alternative is preceded by the “and” term, may be understood to mean that only one of the list of alternatives may apply, more than one of the list of alternatives may apply or all of the list of alternatives may apply. This expression may be understood to be equivalent to the expression “at least one of:” followed by a list of alternatives separated by commas, and wherein the last alternative is preceded by the “or” term.

Any of the terms processor and circuitry may be understood herein as a hardware component.

As used herein, the expression “in some embodiments” has been used to indicate that the features of the embodiment described may be combined with any other embodiment or example disclosed herein.

As used herein, the expression “in some examples” has been used to indicate that the features of the example described may be combined with any other embodiment or example disclosed herein.

1-32. (canceled)

33. A method, performed by a first node operating in a communications system, the method being for handling one or more machine learning (ML) models and comprising:
determining, using ML, one or more ML models of an indicator of operation of the communications system, the determining being based on a respective operation mode of Radio Access Technology (RAT) used by a respective set of nodes wherefrom respective data has been collected to train, or infer, a respective ML model of the one or more ML models, and
providing a respective indication of the determined one or more ML models to a second node operating in the communications system.

34. The method of claim 33, further comprising at least one of:
obtaining the respective data from the respective set of nodes, wherein the data is collected from a plurality of sets of nodes, and
determining the respective operation mode of RAT of each respective set of nodes in the plurality of sets of nodes, such that a respective set of data is selected for training, and/or inferencing from, a respective ML model for a respective operation mode of RAT.

35. The method of claims 34, wherein a same node in the plurality of sets of nodes operates with different operation modes of RAT at different respective periods of time and yields respective subsets of data for each respective operation mode of RAT of the different operations modes of RAT, and wherein the determining of the respective operation mode of RAT of each respective set of nodes is performed for a respective period of time.

36. The method of claim 33, wherein a respective set of data is selected for training, or inferencing, a respective ML model for a respective operation mode of RAT, wherein the respective set of data has been collected from a respective set of nodes using the respective operation mode of RAT, and wherein the method further comprises:
extracting, out of the collected data, a respective set of one or more features from each respective set of data in order to train, or infer, the respective ML model.

37. The method of claim 33, wherein the determining of the one or more ML models comprises a training phase, during which the one or more ML models are trained with additionally collected data, and an inference phase, wherein the inference phase is reached once a desired respective accuracy level of the one or more ML models is reached.

38. The method of claim 33, further comprising:
performing one or more actions based on the respective indication of the determined one or more ML models, wherein the one or more actions are interventions, and wherein the one or more actions comprise at least one of:
a. balancing of traffic in the communications system,
b. management of an indicator of performance of the communications system, and
c. at least one actuation.

39. The method of claim 33, wherein at least one of:
a. the indicator of operation comprises one of:
i. one or more respective first indicators of a one or more Key Performance Indicators (KPIs),
ii. one or more second indicators of handover, and
iii. one or more third indicators of one or more operations based on a level of service in the communications system,
b. the data comprises at least one of:
i. first data comprising information about the respective site where the data was collected,
ii. second data indicating performance management data,
iii. third data indicating fault management data,
iv. fourth data indicating configuration management data,
v. fifth data indicating call trace records, and
vi. sixth data comprising historical data,
c. the respective operation mode of RAT comprises at least one of:
i. Stand Alone, SA, operation with one RAT,
ii. Non-SA with a first RAT,
iii. Non-SA with a second RAT,
iv. Spectrum sharing between the first RAT and the second RAT, and
v. Carrier aggregation, CA,
d. the respective operation mode of RAT comprises at least one of:
i. SA operation with one RAT, wherein the one RAT is New Radio (NR),
ii. SA operation with Dynamic Spectrum Sharing, DSS, wherein spectrum is shared between NR User Equipments (UEs) and pure Long Term Evolution (LTE) or Evolved-Universal Terrestrial Radio Access New Radio Dual Connectivity (ENDC-LTE or ENDC-NR) UEs, and
iii. SA operation with CA, and
e. the communications system comprises one of:
i. a Fifth Generation (5G) architecture, and
ii. a Fourth Generation (4G) architecture.

40. A method, performed by a second node operating in a communications system, the method being for handling one or more machine learning (ML) models and comprising:
receiving, from a first node operating in the communications system, a respective indication of one or more ML models of an indicator of operation of the communications system, the one or more ML models being based on a respective operation mode of Radio Access Technology (RAT) used by a respective set of nodes wherefrom respective data has been collected to train, or infer, a respective ML model of the one or more ML models, and
performing one or more actions based on the received respective indication of the one or more ML models.

41. The method of claim 40, wherein at least one of:
a. the one or more actions are interventions,
b. the one or more actions comprise at least one of:
i. balancing of traffic in the communications system, and
ii. management of an indicator of performance of the communications system, and
c. the one or more actions comprise at least one actuation.

42. The method of claim 40, wherein the respective data is first respective data, the respective set of nodes is a first respective set of nodes, and wherein the method further comprises at least one of:
obtaining second respective data from a respective second set of nodes, wherein the data is collected from a plurality of second sets of nodes,
determining the respective operation mode of RAT of each respective second set of nodes in the plurality of second sets of nodes, such that a second respective set of data is selected for inferencing a respective ML model for a respective operation mode of RAT, and
inferencing the one or more ML models indicated by the received respective indication, using the second respective set of data, and based on the determined respective operation mode of RAT, to make a respective prediction or detection of the indicator in the determined respective operation mode of RAT, and wherein the performing of the one or more actions is based on the respective prediction or detection.

43. The method of claim 42, wherein a same node in the plurality of second sets of nodes operates with different operation modes of RAT at different respective periods of time and yields respective second subsets of data for each respective operation mode of RAT of the different operations modes of RAT, and wherein the determining of the respective operation mode of RAT of each respective second set of nodes is performed for a respective period of time.

44. The method of claim 40, wherein at least one of:
a. the indicator of operation comprises one of:
i. one or more respective first indicators of a Key Performance Indicators (KPIs),
ii. one or more second indicators of handover, and
iii. one or more third indicators of one or more operations based on a level of service in the communications system,
b. the data comprises at least one of:
i. first data comprising information about the respective site where the data was collected,
ii. second data indicating performance management data,
iii. third data indicating fault management data,
iv. fourth data indicating configuration management data,
v. fifth data indicating call trace records, and
vi. sixth data comprising historical data,
c. the respective operation mode of RAT comprises at least one of:
i. Stand Alone, SA, operation with one RAT,
ii. Non-SA with a first RAT,
iii. Non-SA with a second RAT,
iv. Spectrum sharing between the first RAT and the second RAT, and
v. Carrier aggregation, CA,
d. the respective operation mode of RAT comprises at least one of:
i. SA operation with one RAT, wherein the one RAT is New Radio (NR),
ii. SA operation with Dynamic Spectrum Sharing, DSS, wherein spectrum is shared between NR User Equipments (UEs) and pure Long Term Evolution (LTE) or Evolved-Universal Terrestrial Radio Access New Radio Dual Connectivity (ENDC-LTE or ENDC-NR) UEs, and
iii. SA operation with CA, and
e. the communications system comprises one of:
i. a Fifth Generation (5G) architecture, and
ii. a Fourth Generation (4G) architecture.

45. A first node, for handling one or more machine learning (ML) models, the first node being configured to operate in a communications system, the first node comprising processing circuitry and memory operatively coupled to the processing circuitry, the processing circuitry and memory being configured to:
determine, using ML, one or more ML models of an indicator of operation of the communications system, the determining being configured to be based on a respective operation mode of Radio Access Technology (RAT) configured to be used by a respective set of nodes wherefrom respective data is configured to have been collected to train, or infer, a respective ML model of the one or more ML models, and
provide a respective indication of the one or more ML models configured to be determined to a second node configured to operate in the communications system.

46. The first node of claim 45, wherein the processing circuitry and memory are further configured to at least one of:
obtain the respective data from the respective set of nodes, wherein the data is configured to be collected from a plurality of sets of nodes, and
determine the respective operation mode of RAT of each respective set of nodes in the plurality of sets of nodes, such that a respective set of data is configured to be selected for training, and/or inferencing from, a respective ML model for a respective operation mode of RAT.

47. The first node of claims 46, wherein a same node in the plurality of sets of nodes is configured to operate with different operation modes of RAT at different respective periods of time, and is configured to yield respective subsets of data for each respective operation mode of RAT of the different operations modes of RAT, and wherein the processing circuitry and memory are configured to determine the respective operation mode of RAT of each respective set of nodes for a respective period of time.

48. The first node of claim 45, wherein a respective set of data is configured to be selected for training, or inferencing, a respective ML model for a respective operation mode of RAT, wherein the respective set of data is configured to have been collected from a respective set of nodes configured to be using the respective operation mode of RAT, and wherein the processing circuitry and memory are further configured to:
extract, out of the data configured to be collected, a respective set of one or more features from each respective set of data in order to train, or infer, the respective ML model.

49. The first node of claim 45, wherein the determining of the one or more ML models comprises a training phase, during which the one or more ML models are trained with additionally collected data, and an inference phase, wherein the inference phase is reached once a desired respective accuracy level of the one or more ML models is reached.

50. The first node of claim 45, the processing circuitry and memory being further configured to:
perform one or more actions based on the respective indication of the one or more ML models configured to be determined, wherein the one or more actions are interventions, and wherein the one or more actions comprise at least one of:
balancing of traffic in the communications system,
management of an indicator of performance of the communications system, and
at least one actuation.

51. The first node of claim 45, wherein at least one of:
a. the indicator of operation comprises one of:
i. one or more respective first indicators of one or more Key Performance Indicators (KPIs),
ii. one or more second indicators of handover, and
iii. one or more third indicators of one or more operations based on a level of service in the communications system,
b. the data comprises at least one of:
i. first data configured to comprise information about the respective site where the data was collected,
ii. second data configured to indicate performance management data,
iii. third data configured to indicate fault management data,
iv. fourth data configured to indicate configuration management data,
v. fifth data configured to indicate call trace records, and
vi. sixth data configured to comprise historical data,
c. the respective operation mode of RAT comprises at least one of:
i. Stand Alone, SA, operation with one RAT,
ii. Non-SA with a first RAT,
iii. Non-SA with a second RAT,
iv. Spectrum sharing between the first RAT and the second RAT, and
v. Carrier aggregation, CA,
d. the respective operation mode of RAT comprises at least one of:
i. SA operation with one RAT, wherein the one RAT is configured to be New Radio (NR),
ii. SA operation with Dynamic Spectrum Sharing, DSS, wherein spectrum is configured to be shared between NR User Equipments (UEs) and pure Long Term Evolution (LTE) or Evolved-Universal Terrestrial Radio Access New Radio Dual Connectivity (ENDC-LTE or ENDC-NR) UEs, and
iii. SA operation with CA, and
e. the communications system comprises one of:
i. a Fifth Generation (5G) architecture, and
ii. a Fourth Generation (4G) architecture.

52. A second node, for handling one or more machine learning (ML) models, the second node being configured to operate in a communications system, the second node comprising processing circuitry and memory operatively coupled to the processing circuitry, the processing circuitry and memory being configured to:
receive, from a first node configured to operate in the communications system, a respective indication of one or more ML models of an indicator of operation of the communications system, the one or more ML models being configured to be based on a respective operation mode of Radio Access Technology (RAT) configured to be used by a respective set of nodes wherefrom respective data is configured to have been collected to train, or infer, a respective ML model of the one or more ML models, and
perform one or more actions based on the respective indication of the one or more ML models configured to be received.

53. The second node of claim 52, wherein at least one of:
a. the one or more actions interventions,
b. the one or more actions comprise at least one of:
i. balancing of traffic in the communications system, and
ii. management of an indicator of performance of the communications system, and
c. the one or more actions comprise at least one actuation.

54. The second node of claim 52, wherein the respective data is first respective data, the respective set of nodes is configured to be a first respective set of nodes, and wherein the processing circuitry and memory are further configured to at least one of:
obtain second respective data from a respective second set of nodes, wherein the data is configured to be collected from a plurality of second sets of nodes,
determine the respective operation mode of RAT of each respective second set of nodes in the plurality of second sets of nodes, such that a second respective set of data is selected for inferencing a respective ML model for a respective operation mode of RAT, and
infer the one or more ML models configured to be indicated by the respective indication configured to be received, using the second respective set of data, and based on the respective operation mode of RAT configured to be determined, to make a respective prediction or detection of the indicator in the respective operation mode of RAT configured to be determined, and wherein the performing of the one or more actions is configured to be based on the respective prediction or detection.

55. The second node of claim 54, wherein a same node in the plurality of second sets of nodes is configured to operate with different operation modes of RAT at different respective periods of time and yields respective second subsets of data for each respective operation mode of RAT of the different operations modes of RAT, and wherein the processing circuitry and memory are configured to determine the respective operation mode of RAT of each respective second set of nodes for a respective period of time.

56. The second node of claim 52, wherein at least one of:
a. the indicator of operation comprises one of:
i. one or more respective first indicators of one or more Key Performance Indicators (KPIs),
ii. one or more second indicators of handover, and
iii. one or more third indicators of one or more operations based on a level of service in the communications system,
b. the data comprises at least one of:
i. first data comprising information about the respective site where the data was collected,
ii. second data indicating performance management data,
iii. third data configured to indicate fault management data,
iv. fourth data configured to indicate configuration management data,
v. fifth data configured to indicate call trace records, and
vi. sixth data configured to comprise historical data,
c. the respective operation mode of RAT comprises at least one of:
i. Stand Alone, SA, operation with one RAT,
ii. Non-SA with a first RAT,
iii. Non-SA with a second RAT,
iv. Spectrum sharing between the first RAT and the second RAT, and
v. Carrier aggregation, CA,
d. the respective operation mode of RAT comprises at least one of:
i. SA operation with one RAT, wherein the one RAT is configured to be New Radio (NR),
ii. SA operation with Dynamic Spectrum Sharing, DSS, wherein spectrum is configured to be shared between NR User Equipments (UEs) and pure Long Term Evolution (LTE) or Evolved-Universal Terrestrial Radio Access New Radio Dual Connectivity (ENDC-LTE or ENDC-NR) UEs, and
iii. SA operation with CA, and
e. the communications system comprises one of:
i. a Fifth Generation (5G) architecture, and
ii. a Fourth Generation (4G) architecture.
